(19) United States
(12) Patent Application Publication
(10) Pub. No.: US 2023/0085548 A1
(43) Pub. Date: Mar. 16, 2023

(54) Laser Apparatus

(71) Applicant: Kilton Hopkins, Berkeley, CA (US)

(72) Inventor: Kilton Hopkins, Berkeley, CA (US)

(73) Assignee: US Innovation Corporation, Berkeley, CA (US)

(21) Appl. No.: 17/943,174

(22) Filed: Sep. 12, 2022

Related U.S. Application Data
(60) Provisional application No. 63/243,745, filed on Sep. 14, 2021.

(51) Int. Cl. F41H 13/00; G02B 7/09; F21L 4/00

(52) U.S. Cl. CPC F41H 13/0062; G02B 7/09; F21L 4/00

(57) ABSTRACT

A power switch component configured to power a laser apparatus. A data storage component configured to store laser apparatus information and a settings and display circuit in communication with data storage. A display configured to read a current setting and configured to display this setting. A trigger component allowing an activation of the laser apparatus so as to energize the laser apparatus to create a laser beam. A firing circuit configured to receive an electrical activation signal from a trigger and generate a firing signal. A power transfer circuit configured to receive the firing signal. The power transfer circuit component transfers power to a laser beam generation component. A power source configured to provide power to the laser beam generation component for generating a laser beam. Output optics are configured to receive the generated laser beam.

### PRIORITY CLAIMS

This non-provisional patent application claims the benefit of U.S. Provisional Application No. 63/243,745 filed on Sep. 14, 2021, the entirety of which is incorporated herein by reference.

### FIELD

The present disclosure relates to directed energy devices. More particularly, the present disclosure relates to methods and apparatus for generating a laser beam in a portable laser device, such as a laser apparatus. For example, such handheld laser devices may comprise a handheld laser apparatus that can generate different types of laser beam outputs, such as a continuous laser beam or a pulsed laser beam. The generated laser beam can be aimed at a prospective target with an intent to damage or harm the prospective target.

### BACKGROUND

Directed-energy sources emit highly focused energy such as electromagnetic radiation (e.g., radio frequency (RF), microwave, lasers, and the like). In one example, directed-energy sources (also referred to as “directed-energy systems” or “directed-energy weapons”) use lasers to aim at and damage or cause harm to an intended target. Certain known directed-energy systems have disadvantages or limitations for use as a handheld or portable apparatus. For example, such known directed-energy systems are generally large and complex systems, making them generally difficult to provide a sufficient amount of power or energy, especially as a portable or handheld system. As such, certain known directed-energy systems generally do not offer a compact or portable design, such as a design that can be carried by an individual, such as a soldier, policeman, or other law enforcement officer for extended periods of time.

There is, therefore, a general need for a cost-effective, high power handheld laser apparatus that has a reduced weight, enhanced balance, stability and utility, while also easy to manipulate and use in the field, especially in combat or during confrontational situations.

There is also a general need for a pulsed, directed energy apparatus or weapon, that has a capacity to generate large energy pulses wherein the apparatus utilizes an energy storage system to discharge these large amounts of energy in a rapid and/or pulsed manner. There is also a general need for a pulsed energy apparatus that may use one or more energy sources wherein the one or more energy sources may be external to the energy apparatus itself.

[symbol]

### SUMMARY

According to an exemplary arrangement, a laser apparatus comprises a power switch component configured to power on the laser apparatus and a settings interface component configured to allow i. a change to one or more settings or ii. a change to one or more configurations of the laser apparatus. A data storage component configured to store laser apparatus information and a display component is in communication with the data storage component and configured to display i. a current setting or ii. a state of the laser apparatus. A display and feedback component is configured to read at least one current setting, the display and feedback component configured to display at least one current setting when a signal is received from the settings and display circuit. A trigger mechanism component is configured to allow an activation of the laser apparatus so as to energize the laser apparatus to create a laser beam and a firing circuit component is configured to receive an electrical activation signal from the trigger mechanism component and generate a firing signal based in part on this electrical activation signal. A power transfer circuit component is configured to receive the firing signal from the firing circuit component, based in part on this firing signal, the power transfer circuit component transfers power to a laser beam generation component. At least one power source component is configured to provide power to the laser beam generation component, the laser beam generation component generating a laser beam. An output optics component is configured to receive the laser beam generated by the laser beam generation component.

According to an exemplary arrangement, the power source component comprises a rechargeable, embedded battery that is enclosed in a body of the laser apparatus.

According to an exemplary arrangement, the power source component comprises an external power source that is external to the laser apparatus. The laser apparatus may further comprise a power port for receiving a cable from the external power source. The external power source may comprise a battery backpack or a wearable battery system.

According to an exemplary arrangement, the laser apparatus further comprises a charge port component for charging the power source of the laser apparatus. The charge port component may comprise a USB port.

According to an exemplary arrangement, the output optics component comprises a focusing component, wherein the focusing component comprises a manual focusing component. For example, the manual focusing component may comprise a rotating ring comprising one or more ridges or rubber grips that facilitate turning or twisting the rotating ring in order to adjust the optical focus of the outgoing laser beam shot.

According to an exemplary arrangement, the display component further comprises a safety switch component configured to prohibit an undesired firing of the laser apparatus when the safety switch resides in an on position.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates a perspective view of a handheld laser beam apparatus;

FIG. 2 illustrates a perspective view of certain components of a handheld laser beam apparatus, such as the laser beam apparatus illustrated in FIG. 1;

FIG. 3 illustrates a perspective view of certain components of a handheld laser beam apparatus, such as the laser beam apparatus illustrated in FIG. 1;

FIG. 4 illustrates a block diagram of certain components of a handheld laser beam apparatus, such as the handheld laser beam device illustrated in FIG. 1; and

FIG. 5 illustrates a block diagram of certain optical components for use with a handheld laser beam apparatus, such as the laser beam apparatus illustrated in FIG. 1.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Therefore, such enumeration should not be interpreted to require or imply that these elements, blocks, or steps adhere to a particular arrangement or are carried out in a particular order.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

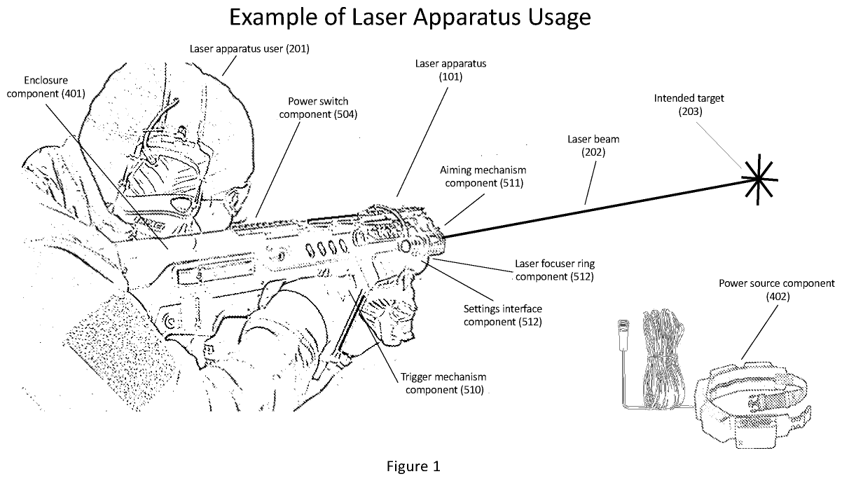

FIG. 1 illustrates a perspective view of a handheld laser beam device 101. For example, such a handheld laser beam apparatus 101 may comprise a laser apparatus having various configurations, such as a compact laser generation component that can be utilized in a apparatus that is mounted on a flying platform (e.g., an airplane, a drone, a helicopter), wherein the laser apparatus is a compact, self-contained configuration. In a preferred arrangement, the laser beam apparatus 101 comprises a portable or handheld apparatus 101 having a size, a shape, and a weight that can be easily managed and manipulated by the device user 201, for example during combat or other similar conflict related activities.

As illustrated, a device user 201 activates the laser apparatus by activating a triggering mechanism 510. Upon activation of this triggering mechanism 510, the laser apparatus 101 comprises a laser beam generation component that generates a final laser beam 202 that the device user aims at an intended target 203 with an intent to cause damage or cause harm to the intended target 203.

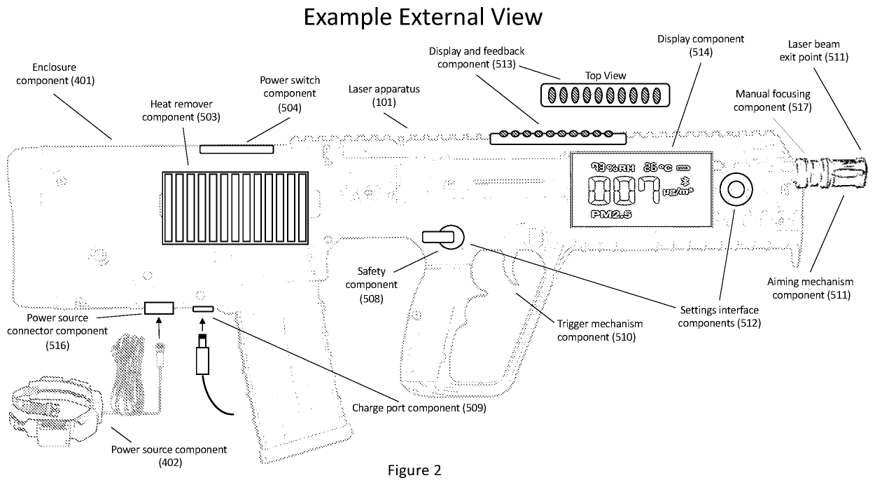

FIG. 2 illustrates a perspective view of certain components of a handheld laser beam apparatus, such as the laser beam apparatus 101 illustrated in FIG. 1. The following paragraphs will identify certain functional components of this laser beam apparatus 101, along with various apparatus parameters, characteristics, and various iterations and embodiments. In addition, the following introductory paragraphs will also list various actions that the device user 201 can perform with the various iterations and embodiments of the laser apparatus 101.

Subsequent portions of this disclosure sections will discuss the distinct components and identify each of the component parts of the laser beam apparatus 101, while describing their functionality, their configuration, their relevance to other components, and the multiple configurations that may be suitable for a variety of uses.

Additional segments of this disclosure will explain the actions that the laser apparatus device 101 performs and describe the functionality of the device in terms of each of these actions. In sum, this disclosure describes an array of functions that the laser beam apparatus 101 can perform in varied scenarios.

As a result, each laser apparatus component will be explained in terms of its operation and position in a functional flow, probably multiple times, since there are components used in diverse ways throughout the system in order to complete specific actions.

The following is a list of the parts and/or components of an exemplary laser apparatus 101:
trigger mechanism component 510;
settings display component 514;
power source component 402,
audio output circuit component 405,
power transfer circuit component 403,
body (or enclosure) component 401,
data storage component 515,
beam generation component 301,
firing circuit component 312,
display component 514,
heat remover component 503,
output optics component 319,
audio output mechanism component 406,
charge port component 509,
aiming mechanism component 511, and
power switch component 504

The following is a list of the actions that can be performed with an exemplary laser apparatus 101, including:
power on
power off
aim
fire
charge
plug in
battery replacement
view settings
change settings
focus
view device status
device wearing
device removal
device “pick up/put down”

Each of these components and actions will be covered individually in the sections that follow.

Body or Enclosure Component

FIG. 1 illustrates a device user 201 firing an exemplary laser apparatus 101. And FIG. 2 illustrates a perspective view of certain components of a handheld laser beam apparatus, such as the laser beam apparatus 101 illustrated in FIG. 1.

As illustrated, the laser apparatus 101 comprises a body or enclosure component 401 that is configured to contain the various component parts of the laser apparatus 101 that can be activated to fire the laser beam 202 towards a target 203. Because the exemplary laser apparatus 101 may preferably be configured as a handheld, portable unit, the laser apparatus comprises an exemplary enclosure 401 that surrounds the other laser apparatus components. This laser apparatus enclosure component 401 provides protection from the elements (i.e., heat, moisture, dirt, debris, etc.), from potential damage, and from additional components becoming unplugged, etc. In this way, the laser apparatus enclosure 401 is similar to those types of enclosures that protect other apparatus devices that might have a working interface.

One proposed purpose of the enclosure component 401 is to protect the laser apparatus both from external elements and common wear and tear to additional components. Additionally, the enclosure component 401 can safeguard internal components from short circuiting. Moreover, the enclosure component 401 can also allow a user of the laser apparatus 101 to mount additional components which may be connected to the apparatus while offering a user the ability to grip or handle the apparatus.

The average electronic device is enclosed to prevent a user from touching bare circuits and causing a short circuit. With regards to the laser apparatus 101, the body of the apparatus needs to be handled, picked up, put down, efficiently manipulated and/or gripped, and aimed. As just one example, if the weight of the laser apparatus is too heavy, the enclosure component 401 of the apparatus can be worn by a user. This means that the enclosure component 401 may need to have loops or eyelets for straps so as to hook onto to make the laser apparatus easier to handle, manipulate, activate, and/or carry. In one arrangement, one or more of these additional components may need to be enclosed in a case similar to a backpack comprising one or more cables connecting to the handheld portion of the laser apparatus. These attachments, loopholes, button snaps, or equivalent add-ons might make the enclosure easier to carry. In one arrangement, the laser apparatus 101 may also comprise a handle that protrudes from a portion of the device (e.g., protruding from the top and/or protruding from the bottom of the apparatus). Such a handle can make the laser apparatus 101 easier to grip and maneuver.

The body or enclosure component 401 of the laser apparatus also needs to be durable. There are several body or enclosure materials that can be considered. As just one example, the body or enclosure 401 of the laser apparatus 101 may be made of a metal, a glass-reinforced plastic and/or a combination of these materials. In an alternative arrangement, the body or enclosure may be constructed from a carbon fiber. However, in one preferred arrangement, the body or enclosure 401 comprises a durable enclosure because the laser device is likely to be used the same way that other handheld apparatus are used. Therefore, the body or enclosure should be able to withstand being dropped without suffering an undesired amount of damage, breaking, fatigue, or jeopardizing certain of its internal systems and/or components.

Furthermore, the laser apparatus body or enclosure 401 should be able to withstand harsh sunlight and extreme outdoor temperatures. As just one example, in certain applications, it would not be uncommon for the laser apparatus 101 to reach 120 degrees if it is being used in bright sunlight in a desert. The laser apparatus enclosure 401 also needs to be able to withstand at least an average level of moisture that a user might encounter in certain operating conditions (e.g., outdoor situations).

In addition, the laser apparatus 101 will also need to be maintained and cleaned. Preferably, the enclosure or body material would not easily accrue dirt, oil, or other substances without the capacity for a user to easily remove them. In one preferred arrangement, the body or enclosure material comprises a type of material that can withstand outdoor environmental conditions, such a material may comprise anodized aluminum, carbon fiber, or glass reinforced plastic, for example.

Furthermore, the enclosure (or the body) 401 of the laser apparatus 101 should be made of one or more materials that does not add substantial weight to the laser device. That is, the material(s) should be light weight material(s) that are light enough to be carried without too much effort. As described herein, if the laser apparatus comprises multiple sections and these multiple sections are coupled, connected, or tethered by one or more cables and/or cords, then the wearable portion of the laser apparatus should be comfortable. In one arrangement, the laser apparatus design structure or configuration could be similar to that of a backpack. However, as those of ordinary skill in the art will recognize, alternative configurations may also be utilized.

In one preferred arrangement, the body or the enclosure 401 of the laser apparatus 101 is configured or structured so as to accommodate one or more components inside of it that have different functionalities. For example, these components will generate heat and will require a stable position. As one example, some laser apparatus components, such as optics, can be extremely sensitive to vibration and/or shock. In addition, the laser apparatus enclosure 401 needs to afford the user access to important human or operator interfaces. As will be described in detail herein, these interfaces may comprise separate components.

Trigger Mechanism Component

The laser apparatus preferably comprises a triggering or activation component 510 that allows the user to trigger or activate the laser apparatus. For example, as illustrated in FIGS. 1 and 2, the laser apparatus trigger component 510 may be positioned along an underside of the laser apparatus 101 so as to enable the device user 201 to activate the laser apparatus so as to create the laser beam 202. In one preferred arrangement, the laser apparatus is activated to energize the laser apparatus so that the laser apparatus generates one or more bursts of energy. The trigger mechanism component 510 does not necessarily need to be the shape that would be commonly found on a typical handheld apparatus, such as a rifle or a handgun. The trigger mechanism triggers or initiates a firing of the laser apparatus 101. For example, in one arrangement, the trigger mechanism component 510 comprises an interface that is exposed on the body of the laser apparatus that allows the user to fire the laser. In one arrangement, this triggering mechanism can be accomplished by pressing a button or by sliding or interacting with any type of prompt.

Where the laser apparatus 101 comprises a button trigger mechanism component 510, such a button arrangement might resemble what someone sees on the door of an elevator, or a home stereo, or the remote control to a garage. In such a button arrangement, the laser apparatus 101 may be activated or fired when a user presses down on the trigger button.

In one preferred arrangement, the placement of such a trigger mechanism component 510 will reside along or near a surface of the body or enclosure 401 of the laser apparatus 101. As just one example, the trigger mechanism component 510 could be located or positioned near the front of the laser apparatus 101. That is, the trigger mechanism component 510 may be located near or adjacent the exit point of the laser apparatus. In other words, in such a configuration, the user may be called upon to use a first hand to steady the body of the laser apparatus while conveniently pressing the button with a finger of a second hand such as a user's foremost hand, nearest the exit point of the laser apparatus.

In an alternative arrangement, the trigger mechanism component 510 is positioned or located near or adjacent a rear portion of the laser apparatus 101. In such an arrangement, the trigger mechanism component 510 could be triggered by the device user's hand that is closest to the user 201 as illustrated in FIG. 1. As just one example, the button or the trigger mechanism that is provided, could be illuminated to make the trigger mechanism component 510 easier to find in the dark, or when the user might be panicking, or when the laser gun device is grabbed quickly.

In one alternative arrangement, the triggering mechanism component 510 is designed as a slider that the user slides or moves in multiple directions so as to ensure that the user wants to fire the laser apparatus 101. As just one example, perhaps a multi-step operation to enact the trigger would be preferable in certain firing or activating situations or circumstances. In one arrangement, the laser apparatus 101 is designed to fire without using one's finger. As just one example, the laser apparatus 101 may be designed to fire by utilizing some other body part, such as a user's foot where the laser apparatus comprises a foot activated trigger mechanism, such as a pedal. As just one example, the laser apparatus 101 may be designed to fire by voice activation. Ultimately, the notion of the trigger mechanism component 510 is that this is the component that is responsible for allowing the user to initiate an activation or a firing operation.

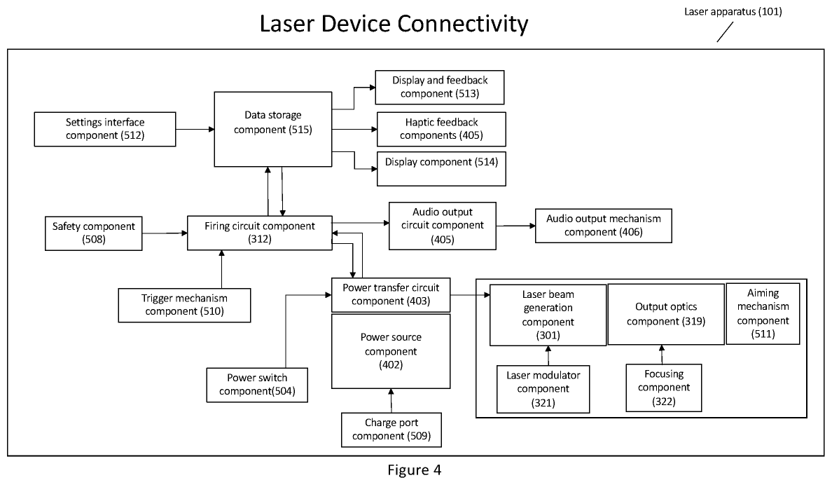

In an alternative arrangement, the activation trigger component 510 comprises a mechanical pull trigger as illustrated in FIG. 2. If the design comprises a mechanical pull trigger, then the laser apparatus 101 may be fired when the action of the trigger mechanism has reached a threshold of firing. That is, the laser apparatus may be fired when the user has pulled the mechanical pull trigger to a certain activation point (i.e., pulled the trigger back a certain predefined distance so as to initiate laser apparatus activation). Once the trigger has been pulled back the certain predefined distance, the laser apparatus produces an electrical activation signal. This electrical activation signal can then be distributed to another apparatus component and/or components contained within the laser gun apparatus, specifically a firing circuit component 312 which will be described in greater detail herein. (See, e.g., FIG. 4)

In yet another alternative arrangement, the trigger mechanism component 510 may comprise a button. If the trigger mechanism component 510 is designed as a button, upon being pressed the button produces an electrical signal that is transmitted to the firing circuit component 312 (See, e.g., FIG. 4). Similarly, if the trigger mechanism component 510 comprises a slider or a switch, the result is an electrical signal that reaches the firing circuit component. This is the functionality and the details of the trigger mechanism, and the various configurations available.

Power Switch Component

As illustrated in FIGS. 1 and 2, the laser apparatus 101 further comprises a power switch component 504. As just one example, the power switch component 504 comprises a top mounted main power switch that in one preferred arrangement comprises a protective cover. Much like the trigger mechanism component 510 of the laser apparatus 101, there are multiple different arrangements and configurations that can be utilized for the laser apparatus power switch component 504. For example, in one arrangement, the device user 201 could power up the laser apparatus by acting upon or pushing a button. For example, for safety or security purposes the power button could be designed in such a way that the device user 201 needs to activate or hold the button for a brief period of time in order to cause a “power on” event of the laser apparatus to occur. This brief period of time may comprise a predetermined period of time (e.g., 2 seconds). In addition, this brief period of time may be a programmable, predetermined period of time, where a user of the laser device 101 programs or selects a time that the button must be activated in order to initiate a power on event.

In one arrangement, the power switch component 504 comprises a rocker switch of the type that features an on-off position. Such a power switch component 504 makes it clear to the user when the laser apparatus 101 is either on or off. In one arrangement, the power switch component 504 comprises an illuminated switch or an illuminated human interface component, such as a push button. Alternatively, the power switch component 504 comprises a toggle switch of the type with a small stem coming off of a toggle switch body. This toggle switch provides an indication to the user that the user has flipped one direction for “On” or the other direction for “Off.” The functionality of the power switch component 504, button, slider, or rocker exists so that the laser gun device can be turned on or turned off.

In one arrangement, when the laser apparatus 101 is in the powered down or “off” condition, certain of the other components of the laser apparatus 101 are inactive or asleep. In this inactive or sleep condition, when the power is off, the trigger mechanism component 510 will not operate. This means that some components might produce the same mechanical movement as when the laser apparatus is on, but the apparatus will not release an electrical signal to the firing circuit component 312. Therefore, a firing operation or firing event will not occur. The power off condition can also mean that the laser apparatus 101 is in a non-ready state or in a power-saving mode. In other words, it can be said that the laser apparatus 101 is in a zero-power consumption state.

In one arrangement, the laser apparatus 101 allows some operations to be available in the “power off” state. One such allowable operation is a change in one or more laser apparatus settings. For example, changing settings, changing the battery, or plugging in the laser gun device are some operations that may remain available in a power-off state.

Alternatively, in the power-on condition, the laser apparatus 101 is ready for operation along with the other apparatus operations.

The power switch or power button component 504 can be placed among many positions or locations along the body or enclosure component 401 of the laser apparatus. For example, the power switch component 504 or power button may be placed on the apparatus in a location that makes it difficult to accidentally activate the laser apparatus 101. For example, this may be a safety design or safety feature that helps to ensure that the user is unlikely to unintentionally turn the laser apparatus on. In addition, the safety design or safety feature can also help to ensure that a user is unlikely to mistakenly or inadvertently power off the laser apparatus 101. As just one example, the laser apparatus 101 may comprise a power switch 504 that is sheltered by a protective cover. Such a protective cover may comprise a piece of material such as metal or plastic (See, e.g., FIG. 2). In one arrangement, such a sheltered power switch component 504 would make it difficult to move the power switch 504 to either the “on” or the “off” position without the user first performing a certain task. This certain task may include the lifting of a cover, a latch, a panel, or other similar restriction type device so that, again, the user is unlikely to change the power status of the laser device without intent.

Aiming Mechanism Component

The laser apparatus illustrated in FIGS. 1 and 2 further comprises an aiming mechanism component 511. In one arrangement, the aiming mechanism component 511 comprises a portion of the body or enclosure component 401 of the laser apparatus 101. In an alternative arrangement, the aiming mechanism component 511 comprises a separate element or module with its own enclosure/body that is coupled to the body 401 of the laser apparatus 101. In a preferred arrangement, the aiming mechanism component 511 is utilized by the user 201 to direct the laser energy output (or the laser shot) 202 produced or generated by the laser apparatus 101 towards a prospective target 203. In one arrangement, the aiming mechanism 511 comprises an aiming mechanism component 511 that replicates a barrel of a standard rifle or handgun through which the projectile, or the bullet, is fired and exits.

In taking the form of a barrel, the aiming mechanism component 511 may be integrated directly into the body or the enclosure 401 of the laser apparatus 101. In such an example, when the user moves the laser apparatus 101, the barrel of the laser apparatus 101 moves along with the apparatus. In such an exemplary arrangement, the barrel is fixed against the laser apparatus enclosure 401 of the laser apparatus 101 so that the barrel cannot move independently from the laser apparatus enclosure 401. In an alternative arrangement, the barrel can move independently from the laser apparatus enclosure 401.

In an alternative arrangement, another “barrel” aiming mechanism component 511 arrangement allows the aiming mechanism component 511 to turn or rotate independently of the laser gun body. As just one example, the aiming mechanism 511 could operate on a swivel, or a pivot, or by way of an inclinable hinge. In these independent aiming mechanism arrangements, the movement of the enclosure or body 401 of the laser apparatus 101 is decoupled from the movement of the aiming mechanism component 511.

In another arrangement, the aiming mechanism component 511 comprises a pointing module similar to the lens of a camera. In this arrangement, the user of the laser apparatus aims the output of the laser apparatus independent of the laser apparatus body. In this arrangement, the pointing module may be tethered by a cable or other similar tethering or cabling means to the laser apparatus body. In such an arrangement, the cable may be either a fiber optic cable, an electrical cable, or other similar type of cable. Through the cable, the laser output disembarks from the laser gun body and arrives at the pointing module. The pointing module is independently directed at a target. In one arrangement, such a pointing module aiming mechanism component 511 is mounted or seated upon a tripod. In such an arrangement, the aiming mechanism component 511 could have hinge mounts, tripod mounts, or swivel mounts that enable the aiming mechanism component 511 to be guided or steered with a certain degree of precision.

Alternatively, the aiming mechanism component 511 might also comprise a wearable module similar to the tethered configuration. With such a wearable module arrangement, the aiming mechanism component 511 might be designed as a rectangular device that contains a lens at the front which the user points to direct the laser. However, it is wearable, meaning that it can be affixed to a vest or a helmet or a mounted shoulder brace. The point is that the aiming mechanism component 511 may, in one configuration, contain its own mounting hardware such that the aiming mechanism component 511 can be worn or affixed to some other piece of equipment or an article of clothing.

Even when it is integrated into the body or the enclosure component 401 of the laser apparatus 101, the aiming mechanism component 511 may comprise a separate component because this aiming mechanism component 511 is the portion of the laser apparatus 101 that is responsible for allowing the user 201 to direct the laser beam output 202 of the apparatus 101.

Settings Interface Component

The laser apparatus 101 illustrated in FIGS. 1 and 2 further comprises a settings interface component 512. As illustrated in FIG. 2, in one arrangement, the settings interface component 512 comprises a top mounted remaining charge indicating strip comprising a plurality of multi-colored LEDs. An exemplary top view of these plurality of multi-colored LEDs is illustrated in FIG. 2.

As described herein, any number of operator interface possibilities are permitted for the settings interface component 512. For example, in one arrangement, the settings interface component 512 comprises one or more buttons, dials, sliders, or switches which may be utilized for one or more of the laser apparatus functions. In an alternative arrangement, the settings interface component 512 may comprise a touch sensitive device, like a resistive or a capacitive touch sensing interface. The settings interface component 512 provides the user with the freedom to change the settings and the configuration of the laser gun device and influence the operation of the laser apparatus. These settings alter the operation of the laser apparatus as the user sees fit.

The settings interface component 512 may comprise a combination of one or more: buttons, momentary push buttons, or push/on-push/off buttons. The settings interface component 512 may also comprise one or more dials. With such a dial arrangement, the user turns a knob clockwise or counterclockwise in order to change the settings of the laser gun. In yet an alternative arrangement, the settings interface component 512 comprises one or more linear sliders which move up, down, left, right, and/or diagonally which can change one or more of the laser apparatus settings.

In an alternative arrangement, the settings interface component 512 comprises one or more hardware and/or software switching devices. These operations might also be altered by switches offering a binary operation such as full-power, half-power or turning on a component. In addition or alternatively, such switches may also be utilized for placing the laser apparatus into a safety mode so that the laser apparatus can be in the “power-on condition” without the capacity to expel a laser beam shot.

In one arrangement, it may be desirable to permit sections of the laser gun body to be sensitive to touch, grip, or twisting motions which would enable the user to modify the settings in a way that they understand. An example of this would be rotating the barrel of the laser apparatus with a first hand while holding the body of the apparatus with the second or opposite hand, such that the degrees of turn allows the user to turn up or down the power of the laser apparatus. For example, the laser apparatus may be provided with perhaps one or more detents (or a clicking vibration) where one or more stopping points are felt/heard as the user rotates the barrel of the laser apparatus.

A primary purpose of the settings interface component 512 of the laser gun device is to allow the user to interact with the settings or operation of the laser apparatus. The user would have an understanding of how these settings affect the outcome that the user desires from the laser gun device. These settings can affect any number of laser apparatus operational activities or configurations.

In one arrangement, the settings interface component 512 is mounted in such a way that the settings interface is accessible to the user in various modes. For example, the settings interface component may be accessible either during a routine operation or by lifting a settings' protection panel similar to the power on/off switch 504 as discussed herein and with reference to FIG. 2. The point is to prevent settings from being changed inadvertently during common carrying, movement, or operation, especially in a stressful situation. In one arrangement, the settings interface component 512 is mounted in such a way that the user can access them easily, yet safely and effectively. These setting configurations may also be customizable.

Power Source Component

The laser apparatus 101 illustrated in FIGS. 1-4 further comprises a power source component 402. FIG. 4 illustrates a block diagram of the laser apparatus 101 illustrated in FIGS. 1-3 illustrating how the power source component 402 interfaces with certain other components of the laser apparatus 101, including the power transfer circuit component 403 and the laser beam generation component 301.

The laser apparatus 101 illustrated in FIGS. 1, 2 and 3 has the capacity of possessing one or more power sources. However, as will be described in greater detail herein, in one arrangement, the laser apparatus comprises only a single power source component 402. However, as those of ordinary skill in the art will recognize, alternative power source component configurations may also be utilized.

One of the primary functions of the power source component 402 of the laser apparatus device 101 is to provide the operating power to all of the laser apparatus's circuitry, as this exemplary circuitry is described and illustrated herein. The power source component 402 also provides a source of power for the generation of the final laser beam 202 itself.

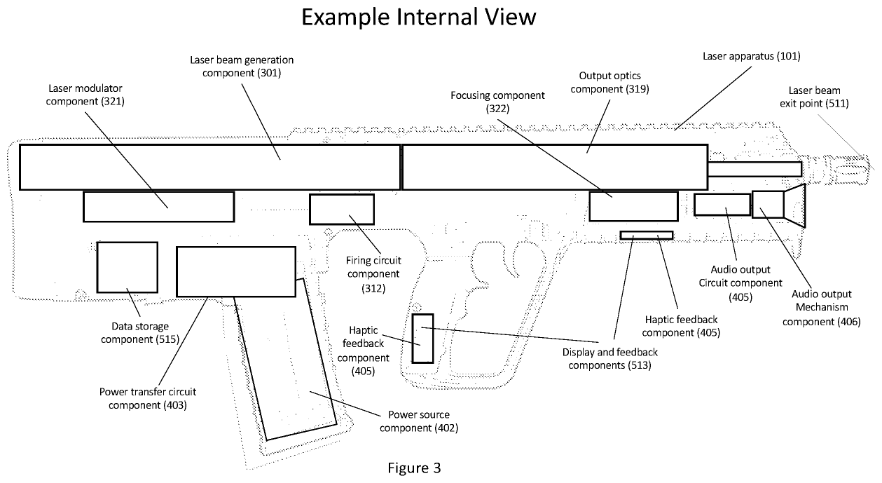

In one arrangement, the power source component 402 comprises a first power source that is dedicated to the central electrical system for operating the device, which may be of a significantly different configuration in terms of the voltage. General operation of the laser apparatus 101 would require a lower current. In addition, in one preferred arrangement, the power source component 402 further comprises a second power source and this second power source in the set requires an ability to generate a higher current so as to power the laser beam generation component 301. (See, e.g., FIGS. 3 and 4)

Given these different types of power requirements being drawn to distinct components, it may be suitable in one arrangement for the laser apparatus 101 to comprise a first power source and a second power source provided as separate power source components. Additionally, the first power source component might comprise a removable power source that the user would change, plug in, or swap. Meanwhile, the second power source component could be an item that is naturally longer lasting, more stable, and more suitable working off of a battery. As such, the power sources component could be in different configurations such that a rechargeable or disposable battery powers the circuitry of the laser apparatus.

In one power source arrangement, it is possible to use various types of batteries, such as high C-rate or discharge-rate lithium-ion batteries, or nickel metal hydride batteries. In such a configuration, each battery could provide a sufficient source of energy for the laser beam generation component 301 of the laser apparatus 101. These batteries could be in the configuration of a removable or hot-swappable battery pack in the form of a removable magazine, similar to a magazine that slides into and slides out of a handgun. In such an arrangement, the user could swap the batteries as needed in order to provide the laser apparatus with an increased amount of power. For example, the laser apparatus 101 illustrated in FIG. 3 comprises a removable main power battery 402 that is mounted in a handle of the laser apparatus 101.

In an alternative arrangement, the batteries are built into the laser gun device 101, fully enclosed. In such a configuration, the batteries are not serviceable in the field. This would mean that the batteries are permanently installed with the laser apparatus 101 and can simply be recharged but cannot be replaced without opening a chamber and performing replacement work. It is possible to provide a high enough current rate, the laser apparatus could comprise a battery that charges up capacitors, such as for example one or more super capacitors. These super capacitors would receive the energy over a period of time until the capacitors have enough stored energy so as to provide a rapid discharge of current into the laser beam generation component 301.

In one alternative arrangement, the laser apparatus 101 is operatively coupled to a power source component 402. As just one example, such a power source component 402 may comprise a cabled or tethered powered source. In such an arrangement, the laser apparatus 101 might be connected by cables to a mobile power bank. As just one example, such a mobile power bank may be in the form of a wearable power bank, such as a backpack or a power belt. For example, FIG. 1 illustrates an exemplary power belt 402 that comprises a plurality of self-contained power modules. As illustrated, the exemplary power belt 402 may also comprise a cable for hardwiring the power belt 402 to the laser beam apparatus 101, such as the power source component 516 illustrated in FIG. 2.

In an alternative arrangement, it is also possible that this mobile power bank does not comprise a wearable power bank, i.e., a power bank that is worn by the user. Rather, the power source component 402 could be a mobile power bank, such as a mobile power bank on wheels. As just one example, the mobile power source may comprise a power source comprising a cart or case that can be pulled or set on the ground and towed from a first location to a second location. The mobile power bank could comprise a power source component that provides sufficient energy for complete operation of the laser apparatus 101. Alternatively, the laser apparatus 101 might also be designed so as to receive a plug into a standard 120 volts AC electrical wall outlet. As those of ordinary skill in the art will recognize, alternative power source arrangements may also be utilized.

In a preferred laser apparatus arrangement, the laser beam apparatus 101 comprises a central rechargeable battery that powers the operational circuitry of the laser apparatus such that the laser apparatus is able to be turned on and off with a self-contained battery. For example, in one arrangement, the self-contained battery may comprise a self-contained removable battery. Preferably, the laser beam apparatus 101 could also utilize the central power source to perform computational functions. Such computational functions may entail calculating how many laser blasts remain based on the other power source's available voltage. Such computational functions may also entail how much battery power remains. Therefore, in this alternative laser apparatus configuration, one central battery, contained within the enclosure in a fixed format or position, is able to be charged and/or recharged.

In an alternative laser apparatus configuration, the power source component 402 comprises a hot swappable (i.e., replaceable) battery system. Such a system may be configured for providing power to the laser beam generation component 301 that has the ability to provide power of a high enough current demanded by the laser beam generation component 301. In one preferred arrangement, the power source component 402 comprises two separate power sources and these two separate power sources work in tandem so as to make the laser apparatus fully operational and functional.

Charge Port Component

The laser beam apparatus 101 illustrated in FIG. 2 comprises a charge port component 509 for receiving power from a remote source, such as an electronics battery. The charge port component 509 may include an optional protective cover. In this illustrated arrangement, the charge port component 509 resides adjacent the removable power source component 402. However, as those of ordinary skill in the art will recognize, alternative charge port component 509 arrangements may also be utilized.

The charge port component 509 is utilized by the user to attach a charging connector charging cable to one (or more) of the apparatus's power sources, such as the removable main power battery 402. In one preferred arrangement, the charge port component 509 is utilized for charging the laser beam apparatus, rather than provide power to the laser beam apparatus 101. In contrast, the power source component 516 is utilized differently than the charge port component 509, wherein the power source component 516 is utilized for both, that is charging and providing power to the laser beam apparatus 101. Alternatively, the charge port component and/or charge cord 509 may be used to attach an external power cable in order to deliver power to the laser apparatus 101 when the energy is not being provided via a battery. The charge port component and/or charge cord 509 can also act as the interface through which the user changes the battery via a hot-swappable mechanism, battery mechanism, or a standard battery transfer when the user needs to power down the laser apparatus and change its battery. As a result, the charge port component and/or charge cord 509 has some differences in the manner and function that it can be utilized and/or configured with the laser apparatus.

In a laser apparatus arrangement where the laser apparatus comprises one or more internal batteries, or at least one internal battery for its central power typical of electronic devices that contain a charge port component 509 (USB or a two-pin connector), a suitable charging port can also be utilized. Such an internal battery may be used to power the circuitry and not necessarily the battery that supplies power to the laser beam generation component 301. In such an arrangement, one suitable charge port component 509 may comprise a USB-C style connector. In an alternative arrangement, the charge port component 509 may comprise a two-pin charging plug, which is a more traditional battery charging plug featuring a positive and a negative tip. Ultimately, if the user can access the charge port component 509 and plug into the charging cable, then that can be a suitable functionality.

In one preferred arrangement, the charge port component 509 comprises a covering such as a rubber, a silicone, a metal safeguard, or any similar material that prevents dirt, debris, or moisture from getting inside the laser apparatus case or enclosure. Preferably, the charge port component 509 is mounted on the laser apparatus enclosure component 501 where the user can access it, but they would need to expose the mechanism in order to charge the device. Multiple configurations of this type would be suitable, and in such a configuration (with the internal circuitry being powered by a battery) the charging is likely to be initiated by the user intermittently. The number of times a user accesses this charge port component 509 may be determined by how often the laser beam apparatus 101 is used: whether someone uses the laser beam apparatus 101 once per week, once per day, for eight hours straight, and so on.

Now, when the user is providing all required device power via a power source connector component 516 versus any kind of a battery power source, it is not a charging port, like the charge port component 509 illustrated in FIG. 2. However, perhaps located in the same sort of position, and also with a weatherproofing cover, the laser beam apparatus 101 comprises a power source connector component 516. Again, this power source connector component 516 could be any number of configurations including a USB-C, USB-A, or USB-B style connector. However, in an arrangement where the power component 516 provides power to both the internal circuitry and the laser beam generation component 301, it is likely that this power component 516 would comprise a robust set of connectors featuring a significant amount of metal in order to conduct the requisite current.

In one arrangement of the power source connector component 516, the power source component 516 is attached via a twist lock or a threaded terminal binding. That is, the power source connector component 516 will be attached with a connecting mechanism that helps to ensure that the power component 516 does not become unintentionally unplugged during laser apparatus operation. Unlike an internal battery that cannot become decoupled from the laser apparatus, decoupling an external power source would mean that the handheld laser gun device needs to receive constant and reliable power from outside of the laser apparatus itself. In the scenario where the laser apparatus could become unplugged, the user could encounter a situation in which he or she is trying to fire the laser apparatus, but the laser apparatus will not perform due to the lack of adequate stored energy. As illustrated in the exemplary laser beam apparatus 101 of FIG. 2, the power source component 402 comprises a cable component for interfacing with the power source connector component 516.

In a preferred arrangement, the power source connector component 516 comprises an external electrical connection on the enclosure component 401 of the laser apparatus 101. This external electrical connection allows the user to attach a power supply by whatever means and of whatever type. As just one example, the laser beam apparatus 101 may include a properly configured mechanical interface, including either a 4 or a 12-pin mechanism.

In yet an alternative laser apparatus battery arrangement, the laser beam apparatus 101 comprises a battery that allows the user to change or replace the battery whether or not there is a charging connector for the battery. In such an arrangement, this includes being able to swap out a battery, whether the battery is hot-swappable or the laser beam apparatus 101 first needs to be powered down. One option for allowing the battery to be changed or replaced would be to design the battery in the configuration of a magazine similar to what one sees on a handgun. In such a magazine related arrangement, the hot-swap battery might slide up into the handle of the laser apparatus. (See, e.g., power source component 402 illustrated in FIG. 3). Alternatively, the hot-swap battery drops into a top portion of the laser beam apparatus 101. In yet another alternative arrangement, the hot-swap battery snaps into the side of the laser beam apparatus 101. In such an arrangement, the battery may comprise a self-contained unit that affixes against, slides into, or snaps onto the enclosure component 504 of the laser beam apparatus 101 so as to create an electrical link or electrical connection.

If the battery needs to be changed by opening a laser apparatus compartment and dropping the battery into this compartment, similar to the way that one changes the battery in a camera, that is also suitable. It could operate more like an electronic device than a typical handheld apparatus. An aspect of this component with the battery change is that a sufficient electrical connection is made when the battery is inserted because the battery supplying the power to the laser beam generation component 301, as described herein, transfers a significant amount of current.

This transferred energy will produce heating in electrical conductors that are undersized, too thin, or lacking in a proper amount of conductive material. An unstable connection could also produce undesired heating, sparking, or potential device breakdown. This potential problem can occur when mating two electrical connections (i.e., two conductors the user attaches and detaches) but then, there is a gap at the point of mating these electrical connections or the battery is too loosely seated. Sometimes, these couplings only make contact on one side, but the other side is disengaged. These situations could produce undesired spark gap scenarios. Such insufficient connection setups can be equivalent to a thin conductor that is capable of generating a large amount of undesired heat. These potential faulty connections can also lead to a potential breakdown in laser apparatus materials and/or components.

A poor connection can be a detrimental situation because the power source component 402 (e.g., the battery that has been inserted into the laser apparatus 101) might be unable to supply enough power to the laser apparatus. In such an event, the laser beam apparatus may fail to operate even though the user has followed the correct procedure for inserting the battery. Ultimately, changing the battery can take on numerous mechanical forms. In such forms, it is an important function of this component to create an electrical coupling that helps to ensure that a sufficient electrical connection is provided so as to provide for the high amounts of current being engaged and maintained. Preferably, the battery is secure not just for movements such as picking the device up and placing it down. The secured battery should also be able to handle movements such as rattling, shaking, or even flipping the laser apparatus.

The electrical connection style makes each configuration function properly. In one preferred arrangement, one battery change can be performed while the device is powered on because there is a first internal battery that maintains power to the circuitry of the laser beam apparatus, and that internal battery can be connected to a charging port. Meanwhile, with regards to the second battery that powers the laser beam generation component 301, the second battery can be interchanged or hot swapped at will by the user in order to provide more bursts of the laser beam or more shots.

In the case of a laser beam apparatus 101 comprising a single battery arrangement, it could be that the laser apparatus must be powered off because that single battery arrangement provides power to both the internal circuitry and the laser beam generation component 301.

In one arrangement, the battery may comprise a wearable backpack that is tethered to the laser gun device by a cable. For example, as illustrated in FIGS. 1 and 2, the power source component 402 comprise a cable for interfacing with the laser beam apparatus 101. However, in this arrangement, a user is charging that battery pack the same way he or she would charge a battery within the laser beam apparatus 101. Eventually, it is all the same in that even if the battery is wearable on a belt (See, e.g., power belt 402 illustrated in FIGS. 1 and 2) or in a backpack, that battery pack still needs to be charged or powered via the mechanisms that are described herein.

In yet another alternative arrangement, the power that is required by the laser beam apparatus 101 is provided by an external resource. Such an arrangement would entail connecting to a power source that comes from outside the laser apparatus in order to power the laser apparatus.

Display and Feedback Component

In one arrangement, the laser beam apparatus 101 provides feedback or apparatus system information to the user through a variety of methods and systems. While these operations are diverse, they amount to a similar type of functionality. There could be an alphanumeric or full multi-pixel, multicolor display as one witnesses on a display screen. In an alternative arrangement, feedback or apparatus system information is provided by way of an alphanumeric display which illuminates or visualizes a certain number of characters or a dot matrix display.

In one arrangement, the body component 401 of the laser apparatus 101 comprises a display and feedback component 513 that is mounted so that the user can access the display component. For example, the display and feedback component 513 may be covered by an impeding or partially impeding apparatus structure that would require the user to lift (or slide or move) a panel or other similar structure. It might also be exposed on the surface of the laser beam apparatus 101. In an alternative arrangement, the laser gun body or enclosure 401 comprises at least one or alternatively a plurality of perforations, slots or apertures in its material. In such a configuration, the display and feedback component 513 may be embedded within the laser beam apparatus 101 wherein an illuminated display component and its information may shine or illuminate through the perforations, slots or apertures provided by the body or enclosure material. Such an arrangement may be configured to protect the display component from outside elements or common wear and tear.

In an arrangement where a dot matrix or an alphanumeric display and feedback component 513 is provided, the user can interact with that display component 513 by looking at it while the device is powered on and, perhaps, initiating the operation by pressing a button that is part of the display configuration. Effectively, the user presses the button and the display lights up and provides the user with information. The information to be displayed is focused on the current settings of the laser gun device 101, which will be discussed in the display circuitry component 514.

In one arrangement, the display and feedback component 513 comprises one or more switches, dials, and/or sliders. In such an arrangement, certain or all of the settings do not need to be displayed to the user via electronic presentation as these switches, dials, and/or sliders where the position of such mechanical units can sufficiently reveal the current settings of the laser apparatus. For example, a dial that can be rotated from a “0” position to a “100” position and stays in a selected position makes it possible for the user to comprehend the settings without accessing an electronic display. However, as those of ordinary skill in the art will appreciate, such a settings component 513 that comprises mechanical units may also comprise a visual display component as well.

For example, an electronic display can be valuable in certain circumstances, even when the laser apparatus settings can be determined by merely looking at the mechanical dials or switches. Such an electronic display can be utilized to indicate or show additional information. This additional information may include information as to whether the laser apparatus is currently powered on or energized, how many laser shots remain given the current battery power level, or the level to which the battery is currently charged. This can be valuable information, as data that might indicate to the user useful information that is related to the way that the laser apparatus will perform and the duration of time that the laser apparatus will operate as called upon by the user.

In yet an alternative arrangement, another means of providing a display and feedback component 513 might be to utilize single indicator LEDs or light bulbs. Power on/off indicator LEDs may also be utilized in the laser apparatus. The single indicator LEDs or light bulbs could be made of any color. As just one example, a blue single indicator LED or light bulb indicates to the user that the device is on, while a red single indicator LEDs or light bulb indicates that the laser apparatus is powered off. In addition, LEDs could be used to indicate whether the safety of the laser apparatus is engaged or disengaged. In that case, the user is able to fire (or not fire) based on the state of the device as indicated by this lighting component. Furthermore, as described herein, some configuration of LEDs might indicate how much power is remaining in the laser beam apparatus. As just one example, the laser apparatus may comprise a plurality of LEDs (e.g., five LEDs) arranged linearly along a surface of the body of the laser apparatus. In such an arrangement, the plurality of LEDs may represent the power of the laser apparatus in 20% increments. As such, if all five LEDs are activated, this lighting component would indicate 100% power. Similarly, with only one LED activated, this lighting component would indicate 20% power. This lighting component could also provide a useful mechanism for the user to get feedback regarding an internal state of the laser beam apparatus while the laser beam apparatus is in operational mode.

In one arrangement, the display and feedback component 513 provides haptic feedback by way of one or more haptic feedback components. For example, the laser beam apparatus 101 illustrated in FIG. 3 may comprises a haptic feedback component. As this term is used herein, haptic feedback comprises some perceptible sensation that the user feels while holding the laser beam apparatus 101. If the user desires to sense tactile feedback when firing the laser apparatus, similar to a recoil of a handgun or any other apparatus, then haptic feedback can be provided, for example, through the handle of the apparatus. Alternatively, or in addition, haptic feedback may be provided through a stabilizing grip at the front of the laser apparatus which the user secures with the other hand. In yet an alternative arrangement, any part (if not the entire device itself) could provide haptic feedback to the user.

The haptic feedback could be generated in the form of a pulsing that is akin to a mechanical bump mechanism. Alternatively, the haptic feedback may be generated by a solenoid that clicks in and out to let the user feel a vibration against their body and in their hands while they are using the device. Alternatively, the haptic feedback comprises a tremor that vibrates to inform a user that the laser apparatus is activating even when the volume is turned off.

Unrelated to firing events, the user may also desire haptic feedback when changing settings of the laser apparatus. For example, a user who is gripping the front of the laser apparatus and twisting it as a way to increase or decrease power may want to know that the device has registered the change in setting without having to visually check the display. In such an arrangement, haptic feedback by means of a method or system of vibrating and/or clicking can assist in informing the user that he or she has changed one or more of the apparatus settings. Obviously, even though the haptic feedback (i.e., the vibration) is informing the user of this change, so too would the data be displayed on the LED screen. The display acknowledges, recognizes, and/or corroborates the change of settings as these changes happen. Similarly, a haptic feedback could be designed that is not initiated by the user. In one arrangement, a specific pulse, series of pulses, a vibration, or a series of vibrations are used to inform a user when they are about to run out of power.

Another feature of display and feedback component 513 is audio. For example, in one arrangement, the laser apparatus 101 produces an audio signal such as a voice or a simulated voice describing the power level. In one arrangement, the laser gun device “announces” when five laser shots or pulses are remaining or when 20% power remains in the battery. In addition, the laser beam apparatus may comprise an audio display that confirms recent setting changes. This can also be accomplished through the sound of a click or a beep or similar signal that the user can hear when interfacing with electronic devices as the user changes knobs and dials or push buttons. Audio feedback can be valuable to the user to let the user know that something they have just pressed or turned has been registered by the laser device. Moreover, in one exemplary arrangement the audio can also be used to share complex information, similar to a dot matrix or a multi pixel display, such that words, digits and/or other alpha numeric symbols can be read aloud and audibly conveyed to the user.

Regardless of its physical configuration or where it is placed on the laser gun body, a primary function of the display and feedback component 513 is to convey to the user information what may not be evident to the user just by looking at the other components of the laser gun device. Utilizing an internal battery means that a user cannot ascertain the battery's status without the aid of an electronic evaluation and reading of the internal battery. A user can determine whether the power cable is attached by inspecting that connection port on the device 101, so that the display does not need to indicate that the power cable is attached. However, to reiterate, the display and feedback component 513 provides the user with information about the state of the device that is not externally and objectively evident.

Audio Output Circuit Component/Audio Output Mechanism Component

As illustrated in FIGS. 3 and 4, the laser beam apparatus 101 may further comprise an audio output mechanism component and/or an audio transducer 406. In this illustrated arrangement, the audio transducer 406 may be provided near the laser beam exit point 511 of the laser apparatus 101. However, as those of ordinary skill in the art will recognize, alternative audio transducer configurations may also be utilized.

The audio output circuit component 405 generates a signal that is used by the audio output mechanism component 406. In one arrangement, this component comprises an electrical circuit that provides an appropriate electrical output signal for driving the audio output mechanism 406. Therefore, engineering choices will determine the type of audio output circuit component 405 to ensure that it coordinates with the audio output mechanism 406. In an arrangement where the audio output mechanism component 406 comprises a mechanical output mechanism, then the audio output circuit 405 produces a signal that turns on (and/or turns off) a motor which strikes an object and makes a sound.

In an arrangement where the audio output mechanism component 406 comprises a piezoelectric buzzer or speaker, the audio output circuit component 405 produces an electrical signal at a desired voltage, frequency, and current level to drive that piezoelectric mechanism.

The audio output circuit component 405 preferably comprises an internal piece of circuitry. That is, the audio output circuit component 405 comprises circuitry that is housed inside the body of the laser gun device so as to prevent undesired exposure to weather elements, dirt, unwanted debris, etc. The audio output circuit component 405 receives its own signals from other components within the laser gun device, such as the display and feedback component 513. The output of the audio output circuit component 405 communicates with the audio output mechanism component 406. Additionally, in one preferred arrangement, the audio output circuit component 405 requires no direct interaction from a user or other third party or laser apparatus component.

In an arrangement where the audio output mechanism component 406 comprises a piezoelectric speaker, this mechanism is capable of producing a volume of sound up to or exceeding 120 decibels. This means that this piezoelectric mechanism is also able to produce softer sounds such as a click, a ding, or a tone suitable so as to provide confirmation that a setting has been changed through the user's interaction with the laser beam apparatus 101. Importantly, this mechanism can produce a firing event sound that is at least a full 120 decibels which is akin to the bang of a handgun or the zap of a laser gun (for example, as created in science fiction movies). In such circumstances, the audio output circuit component 405 comprises a design that is able to produce the electrical signals for a wide array of sounds at the appropriate level and wave form, causing the audio output mechanism component 406 to generate the applicable noise at a desired or programmed volume level.

In one arrangement, the audio output circuit component 405 comprises a fixed electronic circuit that comprises a plurality of resistors and capacitors. As just one example, the audio output circuit component 405 comprises a fixed semiconductor timer such as a 555-timer chip that produces a set number of sounds at one or more designated or particular signal or volume levels. Alternatively, the audio output circuit component 405 comprises a flexible digital-to-analog converter that takes in a sound file, such as an .MP3, .WAV, or any of the common computer file formats, and generates an appropriate output signal that the audio output mechanism component 406 can consume in order to perform its task.

In one preferred arrangement, the audio output circuit component 405 has flexibility in its design. In one arrangement, there remains a possibility that the laser gun device only needs to produce one sound which means only providing a signal that turns on a motor that creates an alarm and/or sound. In one preferred arrangement, the laser beam apparatus 101 converts incoming data files as an array of sounds at various volumes.

Finally, in one preferred arrangement, the inputs to the audio output circuit component 405 need to be a receiving signal path such as a positive voltage input. This means that the inputs are connected to the common electrical ground of the entire laser apparatus and receive voltage on a single wire as an input. As a result, the audio output circuit component 405 produces one output signal that is communicated to the audio output mechanism component 406 and creates a sound that can be turned on or off by the presence of a voltage.

In an alternative arrangement, an alternative input would be sending a computer data signal or an electronic data signal which transmits a sound file or a numeric code indicating which audio signal the audio output circuit component 405 is being commanded to produce. For this operation, an electronic data pathway is suitable, including serial peripheral in-connect (SPI), I²C, or similar mechanisms can also be used on a circuit board that allows devices to communicate with each other. In an alternative arrangement, it could also be a sequence of wires allowing the transmission of binary information in parallel. The functionality of the device is the same regardless of the engineering choices. The only variant is the circuit complexity, which corresponds to the decision of how many audio signals it needs to produce which correlates to layout decisions regarding the audio output mechanism 406.

In a preferred arrangement, the audio output circuit component 405 comprises a digital analog converter circuit that receives a digital audio file (e.g., a .WAV or .MP3) and produces an output signal. It is this output signal that drives a piezoelectric speaker or buzzer at one or more volume levels. The audio output circuit component 405 can also comprise the intelligence to convert the audio file and play it for its duration. In such an arrangement, the audio output circuit 405 is coupled directly to the positive and negative terminals of the piezoelectric audio output mechanism component 406. Given that it provides flexibility, future capabilities, and a wide array of audio outputs, this is a preferred design of the audio output circuit 405.

Display Component

Similar to the audio output circuit 405, the display component 514 does not need any exposure to the outside world or to the user. Therefore, the display component 514, in one preferred arrangement, resides completely enclosed in the body of the handheld laser apparatus. The display component 514 is primarily responsible for producing one or more electrical signals that are used by the display and feedback component 513 in order to show information to the user. If the display configuration comprises a visual display that displays alphanumeric text, then the display component 514 produces one or more of the electrical outputs that power and configure those pixels.

The display component 514 receives as input the information that needs to be displayed and will then re-read that information before using it to produce an appropriate output signal. As just one example, if the display component comprises a sequence of LEDs, then the display component 514 would be responsible for accepting the information that it is required to display as input before determining how many LEDs need to be illuminated in order to display that information properly. As the outputs may also include haptic feedback or audio feedback, the display component 514 is also responsible for producing those signals which are intended to reach the next circuit in line in order to produce those outputs.

For example, consider a scenario where a user has changed the settings of the laser apparatus. As the setting has changed, a signal is received at the display component 514 indicating that a setting has been changed, altered, or updated and now that change or alternation needs to be displayed. In tandem with the change in the number of LEDs that need to be illuminated, the display component 514 also passes one or more signals to the audio output circuit component 405. These signals indicate, in part, that the audio output circuit component 405 produces an audio output signal that is aligned with that setting change. Such an audio output signal may comprise a click, a tone, or other similar audible indication that can somehow inform the user that a setting has been altered. In one preferred arrangement, these actions, both the illumination of the LEDs and the corresponding audio emissions, transpire simultaneously. In an alternative arrangement, these actions transpire in a serial fashion, one after the other or may even overlap with one another. However, as those of ordinary skill in the art will recognize, alternative illumination, LED, and audio emissions configurations may also be used.

In continuing with this arrangement, the LEDs would be changing the voltage from zero to some positive voltage (e.g., five volts) for each of the LEDs intended to be illuminated while leaving the remainder of the LEDs at a zero voltage in order to prevent them from being illuminated. Therefore, the display component 514 operates as a driver for the chosen display configuration.

In an alternative arrangement, the display component 514 may also be responsible for retrieving settings information and then using this retrieved information to determine what to display and how to display it. To demonstrate this functionality, consider that the power level of the laser apparatus is adjusted using a manual adjusting mechanism (e.g., rotary potentiometer with a knob) that is exposed to the user on the outside of the laser gun device body. Basically, the user can turn the manual adjusting mechanism from one position indicating zero or minimum power to another or second position, perhaps a half rotation to the right or clockwise, which would indicate full power. As the user turns that knob, which is a part of the settings component, the display component 514 is receiving the information from that potentiometer in the form of a varying signal or voltage level.

Granted, it is possible that the design of the laser gun device 101 is such that the dial communicates to the device user 201 what the power level is by featuring a white line on the dial that corresponds to markings on the body of the gun. Still, as the display component 514 receives that change, the design of the laser gun device 101 may also include a sequence of a plurality of LEDs (e.g., ten (10) LEDs) that provide a visual representation of the power level adjustment. By having more than one indicator, information about the laser beam apparatus 101 can be received from multiple angles. Depending on the placement of the LEDs, a user could see these changes by looking directly down upon it from above even as he or she turns the knob on the side of the laser gun device.

In summary, the display component 514 receives the change by way of an electrical signal from the rotary potentiometer in the form of a dial. With that change in voltage, the display component 514 performs the electrical processing needed to translate the required amount of voltage to illuminate the specified number of LEDs, indicating the accurate level of power.

In this configuration, the display component 514 is responsible for both i. powering the LEDs, and ii. producing an output signal to drive the LED display. In this configuration, the display component 514 may also be responsible for receiving information from the actual settings component itself so that the display component 514 can determine the information that needs to be displayed.

In an alternative arrangement, the display component 514 is configured to be capable of querying a data store, or performing a data storage, that reads the current settings information. After reading the current settings information from the data storage component 515, the display component 514 translates that settings information into the alphanumeric display pixel to drive the display component 514 if the display component 514 comprises a visual or multi-pixel screen. Therefore, the display component 514 is similar in certain respects to the audio output circuit component 405 because the display component 514 complexity can be determined by certain design choices that can be made in relation to the laser beam apparatus 101 and the apparatus requirements. In this case, what needs to be considered is the method or methods of display as well as the method or methods by which a user makes changes to the settings of the laser beam apparatus 101.

In a preferred arrangement, the input signals to the display component 514 are varied depending on the configuration. For example, the inputs might comprise wiring that attaches directly to one or more buttons, switches, or dials that are part of the settings component 514. It is possible these inputs might comprise data input similar to the audio output circuit component 405, operating via a serial peripheral interface (SPI) or I²C (a synchronous, multi-master, multi-slave, packet switched, single-ended, serial communication bus) or some other communications bus. Other components in the laser gun device 101 can pass the data in alpha or numerical form to the display component 514 in order for the settings and display circuit 514 to perform its display functions.

Firing Circuit Component

In a preferred arrangement, the firing circuit component 312 comprises a fully encapsulated electronic circuit or circuits that are embedded entirely inside the body or enclosure of the laser apparatus. In this preferred arrangement, the firing circuit component 312 needs no exposure to the user or to the outside world. The firing circuit component 312 is responsible for receiving the firing event input from the trigger mechanism (whatever the configuration of the trigger component as herein described) before using this information about the firing settings to determine what output to provide upstream to the power transfer circuit component 403. As described in detail herein, the power transfer circuit component 403 influences the laser beam that is generated by the laser beam generation component 301.

On one end, the firing circuit component 312 relies upon input from the trigger mechanism component 510, which may be connected by a single wire that carries an electrical signal when the trigger is pulled or when a button is pushed. This action indicates to the firing circuit component 312 that the user desires to initiate a firing event. The next step is for the firing circuit component 312 to solve, compute, extrapolate, and/or calculate what signal to send to the other components of the laser gun device responsible for generating the laser beam (e.g., powering the beam generation component 301) and, ultimately, the output laser beam.

The settings of the laser gun device 101 may include power levels and settings for firing modes like a burst duration mode. In one arrangement, the setting allows a user to determine the length of the laser beam burst. As discussed herein, such settings can be changed via different configurations of the settings components and how a user physically adjusts the settings components. The result is that information about the power level will be stored as data in another component. Alternatively, the procedure includes a potentiometer attached to a dial that can be turned up or down by the user to adjust the power level.

For example, assume that a user adjusts the dial or potentiometer authorizing the laser gun device 101 to fire a beam at full (e.g., 100%) power during its next firing event. The firing circuit component 312 reads the output voltage coming from that potentiometer in the same way that the settings in the display circuit component accept a signal requesting a change to the display circuit component. The firing circuit component 312 reads information in order to determine how much power the firing circuit component 312 should allow to flow to the laser beam generation component 301. In addition, the firing circuit component 312 determines how powerful of an output laser beam to produce. In this setting circuit arrangement, the firing circuit component 312 can read the settings information by accessing a slider, a dial, or similar physical and/or electrical configuration that has been designed as the settings component.

Alternatively, in the case where the settings are stored as data, the user is able to turn a rotary encoder. Turning of the rotary encoder is interpreted by the settings in the display component 514 as a change in the settings data. The display component 514 takes this information and then writes this information to the data storage component 515, and the display component displays the output as text, indicating a “100%.” As such, the firing circuit component 312 needs to access this data. So, the firing circuit component 312, like the settings in the display component, is capable of accessing the settings data from the data storage component 515. Finally, using that numeric value data of “100,” the firing circuit component 312 calculates the amount of power that should flow to the laser beam generation component 301 by way of the power transfer circuit component 403. Whether it is a voltage from a potentiometer or the numeric value 100 indicating the percent, the type of required power calculation is substantially similar.

Among other characteristics, the firing circuit component 312 is responsible for the duration of the firing event. In one preferred arrangement, the laser apparatus 101 is configured to generate various types of firing modes, such as a burst mode, a shot mode, and a combination of such modes. In one arrangement, a user adjusts the laser apparatus to fire shots from as quickly as five milliseconds of duration to shots with one-half second of duration between the shots. Perhaps in one arrangement, there are numerous evenly spaced increments between these time frames from which the user can choose and subsequently modify. In one arrangement, this may be made available to a user via one or more “up and down” keys or buttons in the display and feedback component 513. In an alternative arrangement, this user flexibility may be made available to the user by way of a slider or a dial that moves between a minimum duration and a maximum duration provided by the laser apparatus.

In addition, the firing circuit component 312 is responsible for reading that information whether it comes from a rotary or a linear potentiometer or from the data stored in the data storage component 515. Then, while determining the amount of power that needs to be supplied to the laser beam generation component 301, the firing circuit component 312 calculates how long to allow that power to flow to the laser beam generation component 301. The firing circuit component 312 will then produce a cutoff at which time the power no longer flows to the laser beam generation component 301 and, therefore, the laser beam generation component ceases to generate a laser beam. In one arrangement, this time frame corresponds with a fair amount of accuracy to the duration value chosen by the user as the setting. In one preferred arrangement, the firing circuit component 312 responds to the chosen settings such that the output duration of the laser beam shot (e.g., the generated laser beam 202 illustrated in FIG. 1) substantially corresponds to the settings chosen by the user.

Disclosed herein are several arrangements to design a mechanism for calculating this data provided to the firing circuit component 312. As just one example, this data may be calculated by way of a microcontroller. Alternatively, this data may be calculated by way of a circuit comprising transistors, resistors, and capacitors to take in the information before producing a signal to the power transfer circuit component 403 as discussed in greater detail herein. This may be a diminishing electrical signal such that once it is below a threshold, power no longer transfers. In that way, it could comprise an electrical signal curve generated by an analog circuit. In an alternative arrangement, it could comprise a digital signal that comprises a plurality of “on/off” pulses that are communicated to the power transfer circuit component 403. The choice here depends on the most beneficial and efficient circuit design to implement while also taking into account reliability and flexibility in terms of the number of configurations or settings that the firing circuit component 312 allows. These choices are driven, in part, by the desired functionality of the laser beam apparatus 101 in terms of a number of available settings and/or the types of settings that are allowed.

In summary, the firing circuit component 312 is responsible for providing a power cutoff that ends the generation of a laser burst or a continuous laser beam. The firing circuit component 312 is also responsible for ensuring that the signal to transfer power to the laser beam generation component 301 does not occur unless a firing event has been initiated or requested by the device user 201. To reiterate, the user 201 must have pulled the trigger or pushed the firing button. It is worth noting that, in certain arrangements, the firing circuit component 312 contains additional inputs that can be used to inhibit the firing such as when a safety setting is turned on. For example, as illustrated in FIG. 2, the laser apparatus 101 may comprise a safety component 508, such as a rotary switch or selector. The safety component 504 may be provided on one or both sides of the laser apparatus 101.

In the scenario where the safety component 508 setting is turned on, the firing circuit component 312 receives the trigger pull event as an electrical signal. But as the firing circuit component 312 performs its job of looking at the settings as contained in the display component 514, the firing circuit component 312 recognizes that the voltage coming from the safety switch part of the display component is high: that is, a firing event is not to be initiated. If the voltage coming from the safety switch part of the display component 514 is high, this would indicate that the safety is turned on and that the firing of the laser apparatus is currently not intended. It uses that inhibitor input coming from a setting to calculate that no power level and no duration should be provided to the power transfer circuit component 403. Therefore, no laser beam output is generated by the laser beam apparatus 101.

Power Transfer Circuit Component

The power transfer circuit component 403 is responsible for receiving one or more electrical signals from the firing circuit component 312, which is the output of the firing circuit. The input to the power transfer circuit component 403 is responsible for receiving and translating a relatively small electrical signal, into a large flow of energy to the laser beam generation component 301. The power transfer circuit component 403 has similar features compared with the audio output circuit component 405, the display component 514, and the firing circuit component 312. As just one example, the power transfer circuit component 403 is encapsulated and should not be exposed to the elements or to the user directly. In addition, in a preferred arrangement, the power transfer circuit component 403 is preferably secured within the enclosure component 401 of the laser apparatus 101.

There are multiple different arrangements of the power transfer circuit component 403. However, the restrictions are that it must be capable of receiving a small data signal similar to a positive 5 volts at a minimal amount of current. As just one example, this data signal may comprise a few milli-amps. The power transfer circuit component 403 then changes its current state so as to allow a large flow of current from the power source 402 to the laser beam generation component 301.

In one arrangement, the embodiment of the device comprises a high discharge rate battery as the beam generation power source 402. The power transfer circuit component 403 needs to be able to accept a small signal indicating that it should allow power flow for a certain period of time. Meanwhile, as that signal is being received, the power transfer circuit component 403 allows the flow of current from the high discharge rate battery through to the laser beam generation component 301.

One way of achieving this desired current flow is through the use of a solid-state relay which is essentially a configuration comprised of a couple of MOSFET transistors that are metal-oxide-semiconductor field-effect transistors. These electronic components are designed to take a small signal and use it to alter their state such that very large signals can flow through the other ends of that component. So, the MOSFET transistors are capable of making a solid-state relay or of performing something like a high-volume-of-electricity switch which then allows a flow of electrons. The response rate of MOSFETs is high speed, meaning that the electrical signal can be turned on and off quickly by varying the input signal to the power transfer circuit component 403. Given the amount of power, the power transfer circuit component 403 may provide parallel electrical pathways such that a plurality of solid-state relays (e.g., 10 relays) or MOSFET transistors are placed in parallel to each other. Such an arrangement allows a certain amount of electrical current to flow through these parallel solid-state relays the aggregate of which is sufficient for the laser beam generation component 301 to perform its intended function of laser beam generation.

It might also be that a single electrical component can allow the amount of flow of energy needed by the beam generation module. These options are determined by the amount of electricity that needs to move from the power source component to the beam generation component. However, the power transfer circuit component 403 needs to be able to alter its state fairly rapidly. That is, the power transfer circuit component 403 needs to alter its state within a brief amount of time that the power transfer circuit component 403 receives the input signal from the firing circuit component 312.

Consider that if the firing circuit component 312 requests or produces a signal that goes to the power transfer circuit component 403 one millisecond from now, the power transfer circuit component 403 must allow power to flow to the laser beam generation component 301 within microseconds. It is not suitable for that circuit to require five seconds to completely open the flow of electrons because that would initiate the firing event at a moment of time long after the user has initially requested it. The delay could be so great that the user may not be expecting it or will fail to aim and fire the laser gun device properly. That said, while it needs to be responsive, it does not need to be hyper-responsive to the point of being instantaneous. As just one example, it may be suitable for the process to take some milliseconds to allow the electricity to flow.

In yet another configuration, rather than utilizing solid-state relays or MOSFETs, the power transfer circuit component 403 comprises one or more mechanical relays. Such mechanical relays are capable of making electrical contact between two very large conductors, so that the mechanical relay can handle the flow of desired electricity.

There are, however, certain engineering challenges with mechanical relays. One challenge is that mechanical relays need to contain a configuration such that too many contact and noncontact events do not result in a breakdown of the electrical conductors. Unfortunately, a high amount of power flowing through a mechanical relay can initiate sparking of the conductors and can require servicing. Another challenge with mechanical relays is the longer delay time due to the mechanical placement of the two metal conductors which is performed by activating an electromagnetic coil that physically moves the conductors together in order to make contact. So, a mechanical relay can equate to a slower response time than what can be achieved by way of utilizing a solid-state approach.

Additionally, mechanical relays are heavier and generally consume, at least in some cases, more power in terms of signal. Therefore, mechanical relays can be bulkier than their solid-state equivalents in terms of functionality. As such, the solid-state relay or MOSFET arrangement has certain advantages over the mechanical relays even though both are capable of performing the functionality of the power transfer circuit component 403.

In summary, the input comes from the firing circuit component 312, and the power transfer circuit component 403 operates as a bridge or a gatekeeper, of sorts, allowing the power to flow between the power source 402 and its intended recipient which is the laser beam generation component 301.

Data Storage Component

In one arrangement, the laser gun device retains the last settings configured or chosen by the user in long-term electronic data storage. The data storage component 515 can utilize a method of storing the information needed by the laser gun device and needed by the user over the course of time. In one arrangement, the configuration for this data storage component 515 comprises a memory card like a CompactFlash or an SD card. In an alternative arrangement, the data storage component 515 comprises a similar technology that is mounted directly onto an internal circuit board or embedded or contained within an integrated circuit, such as a microprocessor. In yet an alternative arrangement, the data storage component 515 comprises an electrically erasable, programmable read-only memory or EEPROM. For example, the data storage component 515 may take the form of flash memory or onboard flash. Ultimately, the data storage component 515 is responsible for storing data or information.

In an arrangement of the laser gun device where the settings are established via mechanical and analog components such as a potentiometer and an on/off switch, there may be no need for the data storage component 515 in terms of a physical presence. However, a purely mechanical and analog laser apparatus design is a less preferred configuration because, with modern state-of-the-art technology, it is viable to produce a more sophisticated arrangement of settings that can be exposed to the user. Therefore, a data storage component 515 has certain beneficial components.

The data storage component 515 receives updated settings information from the display component 514 which will read the output of the settings components in the form of buttons, switches, sliders, rotary encoder knobs, etc. and produce an update to the settings. Meanwhile, the display component 514 will operate the display by producing an output to the data storage component 515 that updates the information. The data storage component 515 also serves as an input to the display component 514 when the display component 514 needs to read the current setting information in order to drive the feedback component.

The data storage component 515 also provides an input to the firing circuit component 312. With this input, the firing circuit component 312, as described herein, reads the current settings from the data storage component 515 and determines what power level and duration of signal to provide to the power transfer circuit component 403. In one preferred arrangement, the data storage component 515 stores information not directly related to settings but related to the functionality of the laser beam apparatus 101 such as audio files. For example, such audio files may be sent to the audio output circuit component 405 responsible for processing those audio files into audio signals. Therefore, in one preferred arrangement, the data storage component 515 serves as an input to multiple additional components and not just to the settings and display circuit and the firing circuit component 312.

In one arrangement, the data storage component 515 handles a high number of data changes without deteriorating. Some data storage technology degrades after a moderate number of writes, erases, and rewrites, as well as writes and reads. The data storage component 515 is able to have its data read and rewritten a high number of times over the lifetime of the laser gun device. A preferred arrangement of the data storage component 515 comprises an arrangement that does not require replacement. In addition, such an arrangement does not deteriorate in performance or reliability until the expected lifetime of the entire laser gun device has ended. In one arrangement, it is possible that the data storage component 515 could be maintained, serviced, or replaced as part of the maintenance of the laser gun device.

Regarding speed and efficiency, the data storage component 515 is capable of providing the requested data quickly. This requested data is the data that is being read by the other components such as the firing circuit component 312 reading the power level setting data, for example. State-of-the-art “read and write” speeds that are currently generated by the aforementioned technologies such as flash and EEPROM are acceptable for the operation of the laser gun device. Because the amount of information to be shared can be relatively small, any data transfer speed of modern technology is suitable. However, as a requirement for this component, it must not provide the data requested so slowly that it alters the operational performance of the device. Moreover, preferably it does not write/update information so slowly that the user is required to change the setting a second time during the interval in which the previous or latest setting was supposed to be recorded.

In addition, the data storage component 515 needs to be reliable in terms of its accuracy. The data retained should not be subject to alteration through outside means. For example, if the user changes a setting via the push of a button or the rotation of a dial, the data storage component 515, after the sequence of events, will receive that new information and will record it. However, if the laser gun device passes through a strong electromagnetic field, for example, a field that is generated by a nearby piece of radio equipment, these generated fields should not be able to alter the stored data in the data storage component 515.

Laser Beam Generation Component

The laser beam generation component 301 of the laser apparatus receives power and generates the laser beam output. In accordance with the present disclosure, there is a variety of available configurations for the disclosed laser beam generation component 301. The output of the laser beam generation component 301 is the actual laser beam, for example the laser beam 202 illustrated in FIG. 1. This is the laser beam 202 that is emitted from the laser gun device 101 and impacts an intended target 203 wherever the laser gun device is aimed.

In accordance to the present disclosure, there are a variety of components of laser beam generation component 301 that can be utilized to produce a laser beam in accordance with the systems and methods disclosed here. Each laser beam generation component 301 approach has its own advantages and drawbacks.

One approach is to directly produce the laser beam utilizing one or more laser diodes. Laser diodes comprise compact, resonant chambers manufactured in such a way that the semiconductor that produces the photons is unable to emit those photons directly. Instead, they go through the resonance chamber, which is all part of the semiconductor. So, in the same space as the common light emitting diode, there exists an optical resonance chamber, and the output of a laser diode is a laser beam. Laser diode devices are commonly used in laser pointers and projection systems to produce images of the various colors at a distance. However, laser diodes produce beams that are not “diffraction-limited.” In other words, the beams produced by these laser diodes spread. They can be difficult beams to control, and these beams rapidly expand in two dimensions in what is called the fast axis and the slow axis. One can correct for the fast axis to try to keep the laser beam in its more common rectangular shape. However, the generated laser beam will still spread and enlarge quickly regardless of the optics that are used to control the beam.

A laser diode beam is produced by applying power to the laser diode with a constant current power supply. The generated laser beam can be operational for a considerable amount of time if some type of cooling is provided to the laser diode module. Similarly, bursts of laser beams can be produced because the laser diode is powered intermittently (e.g., in spurts). Upon powering the laser diode module, the module produces a synchronized output laser beam that is synchronized with an input electrical pulse. Another advantage of the laser diode module is that the generated laser diode beam can be focused as opposed to trying to collimate the beam so that the generated beam remains straight. Instead, the generated laser beam can be brought to a focal point and then implemented so as to deliver a considerable amount of energy. For example, by using a laser diode in this manner, a power of 10 watts can be achieved.

Therefore, in one arrangement, the laser beam generation component 301 would be that the input to the laser beam generation component 301 is the electrical power that is passing through the power transfer circuit component 403 and arriving through that circuit from the one or more power source components 402. In this arrangement, the power goes directly to the laser diode terminals to provide power to the laser diode. Consequently, the power that arrives is turned into a laser beam. So, if one second of sufficient power arrives through the power transfer circuit component 403, then the laser diode will produce an output laser beam for one second. However, the output laser beam will need to be focused in order to deliver enough energy to an intended target. While this is attainable, it also means that the target must be within a certain range of the laser apparatus. In addition, the user will likely need to refocus the generated laser beam in order to impact an intended target with a significant amount of energy. In one arrangement, the presently disclosed laser apparatus systems and methods utilize such a laser diode based version of the laser beam generation component 301.

To create a controlled, compact, and effective laser beam for output, alternative laser beam generation component 301 may also be used, aside from the straight laser diode arrangement. For example, alternative arrangements comprise techniques and methods that comprise pumping a material that is sensitive to certain wavelengths of light with a sufficient amount of that wavelength of light so that the material accepts those photons in the form of an elevated electron state in the atoms. The goal of this pumping activity is to produce enough atoms in the population (throughout that material) so that a cascade of output photons is produced. This is known as the population inversion, and the technique is to prepare a material with an energetic state such that when you sweep through it with the next photons, it triggers an avalanche. Everything dumps at once, and the result is a powerful output beam that is generated from pumping up that material beforehand. Essentially, it is a method and system of concentrating the energy that is being pumped in to generate a coherent, aligned, and simultaneous powerful laser beam.

There are several arrangements within this method that can be utilized with the laser apparatus systems and methods disclosed herein. For example, one arrangement utilizes a pump light source that emits flash pulses similar to how certain cameras had a flash bulb that would charge and then discharge an amount of light after a determined amount of electricity had been stored. With this technology, the photographer has to wait for some time for that flash lamp to be ready to shoot again. The point is there is a high number of photons being released in that moment. So, flash lamps or an equivalent type of technology can be used to pump a large number of photons into a material such as a lasing crystal.

One type of material that can be used as a lasing crystal is yttrium aluminum garnet (YAG). YAG is a carrier crystal that can be doped with a proper doping element for light absorption and lasing applications. One example of such a doping element is neodymium. Neodymium-doped YAG might exist in a chamber where the flash lamps would pump an amount of light. In one arrangement, the system may comprise reflectors that allow that light to echo around in that chamber as many times as possible, passing through the material as many times as possible, and, pumping and cascading that material as much as possible.

In this arrangement, the output laser beam (such as the laser beam 202 illustrated in FIG. 1) is a different light wavelength than the pump wavelength. For example, a typical output wavelength for neodymium is 1064 nanometer. If this wavelength is not desired, the output of the lasing crystal may be passed into a second harmonic generation crystal known as a frequency or wavelength converter crystal. As just one example, potassium titanyl phosphate or KTP is one type of second harmonic generation crystal that may be used for this procedure. Now, the two crystals in a line process the light, and what is generated is light having a wavelength half that of the 1064 nanometers (i.e., 532 nanometers) which is green rather than infrared, and that might be the desired wavelength.

The presently disclosed arrangements of the laser beam generation component 301 disclosed herein produce an output wavelength that is specific to that technology or set of wavelengths. Furthermore, it may be desirable to have a shorter wavelength or a higher frequency (these outcomes are synonymous) because it means a higher concentration of the laser beam energy at a greater distance. Longer wavelengths disperse more quickly than short wavelengths, and it is generally more difficult to produce the same amount of energy on a target at a distance.

In the method of flash pumping a lasing crystal before optionally passing it through a wavelength conversion crystal, the optical cavity in which the crystal sits, a reflecting mechanism is provided. The reflecting mechanism allows the photons to echo back and forth to build up the laser beam. Such a configuration allows the laser beam to oscillate or intensify until the beam is powerful enough so that the laser beam that is generated and then emitted from the laser apparatus is of a desired usable strength. In this case, the laser beam generation component 301 comprises an optical cavity such that the light resonates between the cavity mirrors until the light eventually exits as the output laser beam.

Unlike a system configuration that utilizes a laser diode, this output beam will be more compact and manageable. This output beam would be in what is known as a diffraction-limited state which means it is collimated, that it will stay in a straight column, and that it will only expand to the degree of the quantum effects of the photons themselves. Since diffraction causes a beam to spread over a distance, this diffraction-limited beam is advantageous. The output shape of this laser beam, if designed to be in TEM-00 mode, will be single point, circular, and nearly Gaussian in its distribution. In such a desired shape, the center of the laser beam is the hottest or the most concentrated part of the laser beam before it tapers off from there with regard to a certain mathematical pattern over a distance.

Other laser modes may be implemented with the presently disclosed laser apparatus systems and methods, but the discussion of different laser modes is outside the scope of describing the laser beam generation component 301. Essentially, all of the laser beams coming out of the laser beam generation component 301 will pass into the next component, which is called the output optics component 319. The shaping, concentrating, and focusing of the laser beam will be performed within this output optics component 319. As discussed in greater detail herein, the output of the output optics component 319 is the actual firing laser beam, which may then be fed or communicated to an aiming mechanism component 511. In one preferred arrangement, the output optics component 319 will be constructed in such a way that adjusts to enhance the characteristics of the generated output laser beam.

Another method that may be utilized with the laser apparatus systems and methods disclosed herein, which method is quite similar to the solid-state laser herein described, is called diode-pumped solid-state lasers. Diode-pumped solid-state lasers do not implement the use of flash tubes or lamps, but rather implement laser diodes. As described herein, with laser diodes the light spreads out rapidly, but it is a relatively straightforward procedure to produce the light from a laser diode. That is, if power is sent to the laser diode, the laser diode will emit photons. The laser diode is a reliable source, and many laser diodes produce reliable wavelengths such that one can get a desired and effective wavelength for pumping certain laser crystals. So, in this case, we are discussing a substantially same design, including the resonant cavity and the potential inclusion of a second harmonic frequency doubling crystal. The only difference is, instead of the flash lamps producing the pump light, laser diodes generate a beam that produces the beam in the laser crystal and resonates there. Therefore, a diode-pumped solid-state (DPSS) laser is another crystal-based resonant cavity laser and is an attractive type of beam to emit from a laser apparatus, such as the laser beam apparatus 101 and methods described herein.

In yet an alternative arrangement, the diode-pumped solid-state laser comprises a fiber laser. With such a fiber laser, instead of crystal and an open-space optical cavity into which one pumps light, the pump diodes—those diode lasers that are producing the pump light—are coupled with one or more fiber optics. Meanwhile, those fiber optics are merged with what is called doped fiber. Doped fiber is similar to crystal in that the fiber is the carrier of the doping element. In one arrangement, this doping element comprises neodymium. In alternative arrangements, this doping element comprises either an ytterbium or an erbium doping element. With this doped fiber arrangement, the atoms of this dopant react to the photons that are embedded in the optical fiber. During this reaction process, as the laser diode light is brought into the fiber, the laser diode light bounces between a center part of the doped optical fiber and passes through these atoms that will accept the photons, pump and reach an elevated state and then be able to cascade.

This is a similar process to what was explained herein except that the optical chamber comprises a fiber optic, and if it is designed in this manner, there might be kilometers of optical fiber in the laser beam generation component in order to provide a long path for pumping to make a high-powered beam. Because one cannot attach mirrors to fiber optics, there are special components for reflecting light back through fiber optic pathways. These special reflecting components are called Bragg gratings, and these Bragg gratings act substantially the same as mirrors do in a free space cavity. This cavity design is similar to the free space cavity design, and second harmonic generation which is also known as frequency doubling can still be performed. However, this frequency doubling method may require the light exiting the fiber optic and then passing this exited light through a free space crystal. This light is then passed back through a focusing or a resonating mirror so as to pass this light back into the fiber optic system.

The output of the fiber laser is, again, a wavelength of light with a high-quality beam. This beam often exits the optical fiber at a very small diameter which would then be brought into the output optics component 319 just like the other of the beams via any of the other methods that are discussed herein. Some advantages of a fiber laser are that the fibers can be jostled around a bit with minimum impact on the operation of the laser apparatus. This is not quite the case with the open-space cavity which requires that the crystals be aligned accurately not only with each other but also in relation to the resonating mirrors. Poor laser apparatus optical component alignment may lead to a cavity break down. With such a cavity break down, no laser light would be amplified or emitted. The fiber laser provides a certain degree of laser apparatus robustness in terms of handling vibration. With such a fiber laser design, it can be easier to achieve alignment because the optical fibers, once attached to the Bragg gratings and the other components, tend to line up as desired.

Alternative laser beam generation components 301 and methods may be utilized as well. For example, there are variations on these techniques such as using a thin slice of crystal called a thin disc, but it is worth mentioning that the solid-state lasers whether it be in fiber or crystals in an optical cavity are attractive in terms of being able to handle a certain level of system vibration. They may also be temperature sensitive and may need to be cooled—perhaps even actively cooled depending on how long they are operating—but these technologies all produce an acceptable beam quality and can be placed into a handheld laser device, such as the laser beam apparatus 101 illustrated in FIG. 1. They may need realignment if the laser gun device is dropped or jostled, but for the most part, these components are relatively stable.

Another arrangement operates on the same principle but is performed with gaseous state rather than a solid state. These are known as gas lasers, and helium-neon is a popular gas combination for producing a laser. Carbon dioxide also produces an acceptable laser with a long infrared wavelength relative to 1064 nanometers, which qualifies as a mid-range infrared wavelength when it is used as a lasing medium. In each of these cases, the gas is excited by an electric arc which results in the emission of some photons and atoms retaining an excited electron state. These can be cascaded since they have been pumped with electricity instead of being pumped with light. To be clear, they can be pumped with light as well, but that depends on the gas and the techniques involved.

Still, it is not as attractive to use a gas lasing medium for a handheld laser gun device. The tubes that are used to retain the gas are by their nature fragile, and the gas may escape. In addition, a gas lasing medium would be more sensitive to vibration and shock, and if a user were to break a glass tube by dropping the laser gun device, they would not have an efficient way to recover it. With the gas lasing medium approach, the alignment would not be as much of a concern. Rather, there would be an increased probability of the gas escaping from a cracked tube, and it could entail a significant amount of maintenance to replace such a cracked tube.

A preferred embodiment among all these viable arrangements for this laser beam generation component 301 would either be the fiber laser (the diode-pumped solid-state laser where the dopant is in the fiber) or the diode-pumped solid-state laser with the bulk crystals that are in a resonant optical cavity. The second option is more compact than the fiber laser design, which takes up more space. This second option, however, is more challenging to keep cool because of the heat that is generated in a more concentrated area. Also, the bulk crystals are more vibration sensitive than the fiber. Clearly, there are some trade-offs with these two arrangements, yet fiber appears to possess certain advantages. First, because of its shock resistance but also since the fiber can be coiled, one could add more doped fiber to the optical path without significantly increasing the length of the device. Lastly, fiber can reach high output wattages, so multi-kilowatt laser beam outputs are possible in that scenario.

Given that the beam generation component 301 receives power through the power transfer circuit component 403 as its input, the implementation for the technology is that the first thing that receives that power as an input is the pump light source (the electric arc source or the laser diode itself). So, it receives power and produces that pump light or, in the case of a laser diode beam generator, the laser beam that has been emitted. Everything from that point on is optical rather than electrical. Although, however, there is some electricity supply going to some other components. If it is a fiber laser, for example, there is likely some monitoring photodiode that will consume a certain amount of power. However, for the most part, the power is substantially consumed by the pump light source. Then, after the laser beam is produced, the laser beam comprises the output beam of this component. Now, the produced laser beam needs to progress in free space or an optical fiber toward the next component of the laser apparatus which is the output optics component 319.

There is another aspect to the laser beam generation component 301 that will be described. That is, the ability of the beam generation component 301 to produce a pulse laser versus a continuous output or continuous wave laser. Pulsing a laser is a matter of preventing the cascade or blocking the output of the laser beam until a greater number of photons or a greater amount of energy has been built up and stored to create a bigger cascade. One method for accomplishing this pulsing effect is to modulate the ability for the laser beam to escape the chamber. The difference between shorter pulses of laser light versus a continuous flow of the laser light is that these shorter pulses can have greater energy. The average power will be the same as it is with a continuous output laser as long as they are based on substantially the same technology. However, the pulses will be stronger, and the pulses will last for a much shorter duration than if one were to just hold the laser beam continuously on a target.

By way of an explanation, the target material of a laser beam will accept the incoming laser light as a source of heat. This means that the target material will absorb at least a portion of the energy. Energy absorption may result in the target material melting, burning, catching fire, decaying, or oxidizing in some way. However, the target material may also be able to radiate away a certain amount of heat fast enough so that the target material will warm without reaching the state of runaway damage.

As just one example, imagine holding a continuous laser beam for a specific period of time (e.g., five seconds) on a target material where the target material comprises a polished metal (e.g., a polished aluminum). Because of the reflective nature of the polished aluminum and the fact that aluminum is a good thermal conductor, the polished aluminum will absorb the incoming laser light. However, the polished aluminum may not absorb enough of the incoming laser light so as to reach a state in which the aluminum begins to be damaged exponentially in a runaway effect. Instead, the polished aluminum might continuously disperse the incoming heat such that five seconds of a continuous laser beam does nothing but warm the surface of the target. This can be problematic if a primary objective of the laser gun device is to impact an intended target with a certain amount of damage. This is where a pulsed laser may provide certain beneficial attributes.

First, most materials have a threshold beyond which the amount of incoming energy is too great for that material to simply absorb and radiate the incoming energy away—or absorb the incoming energy as atomic motion which is thermal energy. Meanwhile, a laser pulse that is 100 times greater than the average power and lasts for a short, predetermined period of time could do more damage than that same amount of energy spread over a continuous one second. Producing pulses is like producing a spike. And this produced spike might be of sufficient energy to cause damage that the continuous wave of laser light could not cause. The produced spike may even induce a runaway damage effect. That is, turning the material into a plasma or producing enough damage that what remains of the surface of the target after a pulse becomes more readily accepting of the next pulse of laser energy. Each successive pulse, then, produces greater impact on the target.

The same configuration as described for the diode-pumped solid-state laser and fiber optic laser exists in the creation of pulse lasers. A difference between these solid state lasers/the fiber optic laser and the pulse lasers is an additional element included in the laser beam generation component 301. This additional element included in the laser beam generation component 301 is a laser modulator component 321. For example, in one arrangement and as illustrated in FIGS. 3 and 4, the laser beam generation modulator component 321 comprises an acoustic optical modulator component 321 where the material vibrates such that the vibrating material deflects the rebounding laser beam inside the cavity. This prevents the material from resonating until the modulation has ceased, but this is just one of a variety of options. Ultimately, each approach uses modulation in order to produce a pulsed output by either preventing the cascade to build up the energy before triggering it or by preventing the laser beam from escaping. One such form of modulation is known as Q switching. With Q switching modulation, a material naturally absorbs the laser light and then allows it to flow and then absorbs it again and allows it to flow again, and it keeps switching on and off, automatically performing its own modulation.

In summary, a preferable arrangement of the laser beam generation component 301 comprises a fiber diode-pumped solid-state laser. In an alternative preferred arrangement, the laser beam generation component 301 comprises a free-space bulk crystal diode-pumped solid-state laser. In a preferred arrangement, these types of diode-pumped solid-state lasers utilize some type of modulation mechanism or modulation component (for example, Q switching modulation) to produce high intensity, short duration pulses as the laser beam output, such as the laser beam 202 illustrated in FIG. 1.

Output Optics Component

The output optics component 319 receives, as an input, the laser beam that is produced by the laser beam generation component 301. After receiving the laser beam from the laser beam generation component 301, the output optics component 319 performs an optical manipulation on the laser beam. For example, this optical manipulation conditions the output beam for the target. Multiple output optics component 319 arrangements will be described herein.

One purpose of the output optics component 319 is to condition the output laser beam. For example, one purpose of the output optics component 319 is to condition the output laser beam such that this laser beam carries the appropriate distance while also remaining in a certain desired concentrated state. In addition, the output optics component 319 allows the beam to focus on the target in a proper shape, at the proper power level, and for the allocated duration of time, for example.

In one arrangement, the output optics component 319 does not comprise a separate output optic component. In such an arrangement, the output optics component 319 comprises an open-air passageway through which the laser beam output from the laser beam generation component 301 can pass. In this first output optics arrangement, the laser beam generation component 301 produces an output laser beam that is substantially a desired configuration. For example, the output laser beam may comprise a desired configuration in terms of a desired beam diameter. In addition, the beam collimation will retain its concentration over a long distance, for example over a distance of approximately 0 meters to approximately 50 meters. Where no modification of the laser beam is needed, a cost-effective and powerful version of output optics is to avoid an active optical element. In such an arrangement utilizing an open-air passageway, the laser beam is already properly shaped and sized.

In an alternative output optics component arrangement, the laser beam generation component 301 comprises a laser diode configuration. That is, the output comprises a straight output coming from a laser diode. In this alternative arrangement, the output optics component 319 comprises one or more optical elements that shapes and/or collimates the laser diode generated beam. The output optics component 319 may also focus the laser diode generated beam to a central point some distance away from the laser beam exit point 511 of the laser apparatus 101. (See, e.g., FIG. 2). For example, such a distance may be about 10 meters or so from the laser beam exit point 511 of the laser apparatus 101. The output optics component 319 forges a rapidly spreading laser diode output into a more concentrated laser beam that is able to carry over a longer distance.

The output optics component 319 may also focus the laser beam from the laser diodes onto a target that is close to the laser gun device. This would effectively limit the device to hitting a target that is within a relatively short distance from the laser apparatus, for example, approximately three feet from the laser beam exit point 511 of the laser apparatus 101. Potentially, such an output optics component 319 could allow the user to adjust the focus of the laser apparatus 101. Adjusting such a focus may occur by the user of the laser apparatus accessing or manipulating some additional mechanical component of the laser apparatus, such as a mechanical component on the outside of the laser gun device enclosure or body. As just one example, this may be accomplished by the user spinning a dial or twisting a lens attachment at the forefront of the laser gun device to adjust the focus of the output optics component 319. In doing so, the user of the laser apparatus could adapt the laser beam to multiple targets at multiple different distances from the laser apparatus.

In yet another alternative output optics component arrangement, a continuation of this concept of having the output optics component 319 perform an adjustment on the output laser beam would be for the optics arrangement to comprise an auto-focus feature or an auto-focus component. In one arrangement, this laser apparatus autofocus technology is similar to the type of autofocus technology found in digital Single Lens Reflex (SLR) cameras where a plurality of sensors are embedded into the optics. As such, this autofocusing feature provides the user with the ability of a “point and shoot” approach. In such devices, ultrasonic motion may be utilized to determine whether the target object is in focus, and in the case of the laser gun device, it would also determine the concentration of the laser beam. In one arrangement, and to simplify the process for the user, the adjustments to the optics and by proxy to the focal length of the laser beam is performed by one or more sensors. As such, this alternative arrangement can eliminate the need for a user to perform for a certain period time a manual action, such as spinning a dial or turning a lens.

In certain situations, focusing of the laser beam, however, may not be a crucial function. In fact, in certain circumstances, focusing can be detrimental to a laser beam that is both well-collimated and diffraction limited. For example, a well-collimated, high-quality laser beam that is diffraction limited can be provided by the output optics to travel a fairly long distance before the laser beam begins to disperse. This distance may be something much more beneficial for a laser apparatus than the ability to adjust a focus to a point that is a relatively short distance away from the laser apparatus, such as three feet away. With a collimated, diffraction limited beam, a user is able to hit a target that is approximately 50-100 meters away with a properly concentrated laser beam shot just by aiming and firing.

In addition, a collimated beam can be beneficial since the collimated beam can impact targets anywhere from about zero meters to approximately 100 meters from the laser apparatus 101. The goal is not to focus the beam on a particular target at the sacrifice of being able to refocus on any other distance. Rather, the goal is the creation of a properly collimated, diffraction limited, high-quality laser beam that can focus on different types of targets up to a certain distance at which the collimated laser beam begins to disperse. This is one benefit of using some of the more complex, higher power laser beam generation technologies as described herein, illuminating the benefits of a diode pump solid state or fiber-based diode pumped solid state.

In an arrangement where the laser beam quality entering the output optics component 319 is of a desired quality, the output optics component 319 is going to perform the task of expanding the laser beam while retaining collimation. A purpose of expanding the laser beam is to help ensure that the laser beam is of a sufficient diameter to retain its concentration for the desired distance. When a laser beam is diffraction limited, that implies that the beam's diffusion will be a factor of the distance that it carries. The diffusion of the laser beam will also be a factor of the starting diameter. These factors will have an impact on how much laser beam spreading may occur over a given distance. It might seem counterintuitive, but a larger initial diameter for a laser beam will result in a longer distance over which that beam will retain its concentration before beginning to diffuse.

For example, a one-millimeter laser beam that has been generated by the laser beam generation component 301 cannot travel very far before the laser beam begins to disperse. As the laser beam disperses, it will therefore begin to lose its concentrated power. However, expanding a one-millimeter laser beam to a larger laser beam (such as, for example, a five-millimeter beam), using beam expander optics while also ensuring that the collimation of the beam is retained after it has been expanded, will produce a concentrated beam that at five millimeters in diameter can travel a greater distance while at the same time retaining its concentration.

Consequently, the output optics component 319 is dependent upon the desired beam focus or collimation preference as its output. In one arrangement, and as discussed in detail herein, the output optics component 319 may further comprise auto-focus or auto adjustment elements. Alternatively, the optics component may comprise a manual adjustment feature. However, in the case of a beam expansion on a high-quality beam entering the output optics component 319, it is likely that the beam expansion arrangement will need to be a fixed beam expansion because the laser beam calibration will already have been completed for the user. What exits the output optics component 319 is a collimated laser beam that is intended to impact targets anywhere from immediately past the laser beam exit point 511 (See, e.g., FIG. 1) to a maximum range, such as for example, approximately 100 meters from this laser beam exit point 511.

There are some durability challenges and requirements for the output optics component. As just one example, laser beams can potentially, especially at high concentrations or in small diameters, damage certain optical characteristics as the laser beams pass through the output optics component 319. As just one example, the laser beam may damage the materials from which the optical components are made. The laser beam may also damage the surface coatings that are present to provide anti-reflection in order to create a higher transmission of the beam, and any other coatings such as those attempting to block backscatter. Given that output optics can actually be damaged by the laser beam, the laser damage threshold of the output optics components, including their coatings, should be higher than the laser beam energy that will be passing through those optic components. Without ensuring that this is the case, the device can suffer a breakdown in the output optics component 319. Certain potential damage may have a runaway effect wherein a small amount of damage can eventually cause the output optical element to receive and accept even more energy from the laser beam instead of passing it through the various output optic components. If this cycle continues, the optical component may fail, therefore preventing the beam from leaving the laser gun device. Instead, the laser gun device may retain the beam within it and possibly bouncing back or distributing its heat within the laser apparatus itself. As such, it is important that the output optics component 319 be properly rated for the power levels of the laser beam shots or bursts that are passing through the laser apparatus.

Heat Remover Component

As illustrated in FIG. 2, the laser apparatus 101 may further comprise a heat remover component 503, such as a laser heat radiator. Such a laser heat radiator may be provided as a switchable laser heat radiator that can be switched from a first side of the laser apparatus to a second side of the laser apparatus. One advantage of such a switchable heat radiator is that it can be switched depending on whether the user of the laser apparatus 101 is right handed or left handed.

As noted herein, several components within the laser gun device 101 generate heat during their operation. If the power source component contains a high discharge rate battery to provide power to the laser beam generation component 301, it is likely that such batteries will radiate some heat in the process of discharging their power. Additionally, perhaps a large heat producing source within the laser apparatus 101 comprises the laser beam generation component 301. Providing power to the pump laser diodes and the DPSS, or to the flash lamps in a bulk crystal or a gas medium arrangement, is typically around 50% efficient. This means that if a laser diode provides the pump light, those diodes may receive 200 watts of power and provide 100 watts of output light. While this is a sufficient level of efficiency, it is quite possible that the efficiency levels will be even lower. In this situation, the remaining energy which may be a considerable amount (i.e., 100 watts) does not make its way into pump light. This means that 100 watts of energy comes through or is dispersed into that part of the system as heat, and heat can change the way that materials behave including pump laser diodes. It can cause the pump laser diodes to produce undesired and different output wavelengths from which they were designed. So, if the desired output wavelength is 808 nanometer, which is a common pump light wavelength, then that laser diode, if it is retaining too much heat, can begin to produce wavelengths much higher or lower than the desired output wavelength, resulting in pump light that is not effectively absorbed by the lasing medium. The result is a beam generation component that can suffer a breakdown in operation. Clearly, the heat being produced in the laser beam generation component 301 must be properly mitigated. It is a primary purpose of the heat remover component 503 to reduce and/or eliminate the heat from the laser gun device components so that potentially heat susceptible components operate within their specified temperature operating ranges and do not fatigue and/or overheat.

There are a number of different heat remover component 503 arrangements that can be utilized by the various laser apparatus embodiments disclosed herein and these may be assembled, configured, and/or built in a variety of ways. For example, in one arrangement, the heat remover component 503 comprises a passive heat remover. In one such passive heat remover configuration, the heat remover which comprises one or more pieces of metal or other materials that are capable of wicking away or transferring the heat away from the components that are generating heat. The passive heat remover comprises a physical structure that allows the heat to be exchanged. For example, a passive heat remover allows the heat to be exchanged between the physical structure and the outside or ambient air.

As just one example, the passive heat remover may comprise one or more component parts of copper or aluminum (or other similar highly thermally conductive material) wherein a first side of the copper or aluminum is placed in physical contact with one or more of the components of the laser apparatus 101 that generate heat. In one arrangement, the other or second side of the copper or the aluminum may be exposed to the open or ambient air. In yet another arrangement, the other or second side of the copper or the aluminum may comprise a geometrical structure (e.g., a finned structure or a blade structure) that is structurally configured so as to allow the heat to be effectively radiated off and exchanged with the ambient air that is passing outside of the laser apparatus 101.

In one arrangement, this approach may have certain parts of the heat remover component 503 enclosed within the body of the laser apparatus 101 but also design vents in the body of the laser gun device such that air can flow in and out. In one arrangement, the laser gun device 101 comprises one or more vents that are arranged in a pattern such that air can move from one side to another side or pass back and forth. Therefore, in one arrangement, the heat remover component 503 is not just open on one side but rather is configured to be open on two or more sides such that air can flow through continuously.

An additional option in this arrangement is to switch from a passive cooling method or passive cooling system to an active cooling method or active cooling system. This would mean including at least one blower fan or similar type of air moving structure or mechanism that is arranged such that the blower fan actively moves air across the heat remover. For example, actively moving air across the fins or similar dissipating structure of the heat sink material. This would enable the heat remover component 503 to dissipate heat more quickly and efficiently. One potential drawback to this form of active cooling, however, is that a fan or blower comprises one or more moving parts and therefore may require service or maintenance over the operational life of the active components. In addition, the blower fan is usually powered by an electromagnetic motor, and electric motors can break down. Additionally, the blower fan can become clogged with external debris such as hair, dust, dirt, and other related contaminants. In addition, the blower fan may also be subject to getting blocked should a piece of material enter those vents and get wedged where the fan blades of the blower fan are trying to rotate so as to move the required amount of air.

Granted, proper physical arrangement may limit the amount of risk to having an active cooling fan, but an ideal arrangement for general robustness and suitability for all weather environments, as well as lower power consumption, would be a passive cooling arrangement. Typically, high-power lasers produce such an excess of heat that active cooling is an option to prevent a breakdown of the device. However, for the handheld laser gun device 101, even though the amount of energy being pushed through the system from the power source all the way through the laser beam generation component 301 and out of the aiming mechanism 511 is intense, it may last for a relatively brief period of time. As a result, as long as the number of laser beam shot repetitions or the frequency of those laser beam shots is low enough, it may be possible to passively radiate the heat away without damaging, endangering, or reducing the operation of the laser beam device 101.

Another option for active cooling of the heat remover component 503 is to use some mechanism or device that provides a source of cold instead of simply radiating heat away or moving the air. Providing a source of cold could be accomplished with a device called a Peltier junction. A Peltier junction is a semiconductor that produces heat on one side of the junction and cold on the other side of the junction. A Peltier junction consumes a fair amount of energy, so in certain configurations it may not be the most energy efficient heat removing option. However, one potential advantage of such a Peltier junction is that it does not comprise any mechanical moving parts. Therefore, the Peltier junction could remove heat by providing cold either directly to the surface of the part that is producing heat, such as the pump laser diode, or by providing that cold onto another material like a block of aluminum or copper that may also have heat sink radiating fins. Now, instead of moving air over those fins, the block is cooled by the Peltier junction, which also produces heat out of its other side and may need to be radiated outward from the device similar to how the passive cooling would work.

In an alternative arrangement, the heat remover component 503 comprises a system and/or method that includes a circulating fluid such as a water-cooling unit in which there is a reservoir of cooler water and a reservoir of warmer water. In one such arrangement, these reservoirs could be attached to a radiating heat sink, and the water would circulate through these reservoirs. Alternatively, the heat remover could also be designed as a single reservoir which begins cool and then begins to warm up as the liquid is passed over the radiating surfaces of the parts at which point it returns to the reservoir after a cycle and deposits or radiates some of its heat outward. In yet another alternative arrangement, the heat remover component 503 comprises a combination of a circulating liquid cooling system with an active airflow cooling mechanism as described herein.

Laser Gun Complete Functionality Walk Through

The present disclosure describes a detailed list of activities that a user can perform with the various arrangements of the laser apparatus and laser apparatus systems disclosed herein. Such methods of use include, but are not limited to the following activities: picking the apparatus up/putting the apparatus down, wearing the apparatus, removing the apparatus, powering the apparatus on/off, aiming, firing, charging, plugging the apparatus in, viewing settings, changing settings, focusing, replacing the battery, and viewing status.

Picking Up/Putting Down the Apparatus

There are only a couple of components involved in the activity of the user picking up and/or putting down the laser apparatus. The most apparent component is the body or the enclosure of the laser gun device.

In the laser apparatus arrangement where the aiming mechanism component 511 comprises a barrel that is a part of the body of the laser gun device 101 and wherein the power sources are entirely contained inside the device, like in the form of batteries, then picking up and putting down the device is a matter of the user handling the body of the laser gun device 101. As this process is the same as picking up or putting down a handgun or a rifle or other existing objects that may look similar, there should be areas on the body that are convenient for the user to grasp. In design terms, these are called affordances.

While affordances comprise those segments of the laser gun device that can be gripped and leveraged in such a way as to allow the user to pick the laser apparatus up, a little bit more complex situation would be where the body of the laser gun device is separate from the aiming mechanism component 511. As mentioned herein, the aiming mechanism component 511 may comprise an object similar to a pointing lens that is on a swivel. It might also be tethered by a fiber optic cable in which case the user picks up the body of the laser gun with one hand, but separately, with the other hand, picks up the aiming mechanism component 511. In other words, in one hand the user holds the body of the laser apparatus 101 which contains the trigger mechanism component 510 to activate the laser beam shot, but in the opposite hand the user secures the mechanism used for aiming.

A detached aiming mechanism component 511 is a variation on picking up or putting down the device. No additional or special function occurs inside of the laser gun device 101 when it comes to the action of picking this device up or placing this device down.

Wearing/Removing the Laser Apparatus

In the configuration where the power source comprises a battery that is tethered to the body of the laser gun device in the form of a backpack, a waist pack or utility belt, or a vest, to fully equip themselves with the laser gun device, the user would need to put on the wearable battery before picking up the laser gun device.

Additionally, if the aiming mechanism component 511 is configured as a rectangular wearable module that can be attached to a person's chest or shoulder, or positioned on a hat or a helmet, then the user must also undergo the action of placing that component on their body. This could be performed by clipping the output lens to the vest or helmet. Removing the device is the opposite action wherein the user takes off the vest or the backpack or unclips the component before placing it down on the table or the ground along with the body of the laser gun device.

User actions like these involve moving, holding, or carrying the externally graspable and portable components of the laser gun device 101. In a laser apparatus design where everything is self-contained in the body or enclosure of the apparatus, including the battery and the aiming mechanism component 511, there really is not any item to wear or remove from one's person other than, perhaps, a strap that can be fed through some loops on the laser gun device body. Such a strap would allow a user to sling the device over his or her shoulder and distribute the weight of the laser apparatus across the user's body. This would also allow the user to let go of the laser gun device to let it freely hang from one's body without it dropping to the ground.

Powering On/Powering Off Laser Apparatus

Powering On

To power on the laser beam apparatus 101, in one arrangement, the user may need to have the laser apparatus in their hand. Alternatively, the user could power on the laser apparatus 101 by interacting with the apparatus as the apparatus rests on a table or on the ground. To power the laser apparatus 101 on, the user is first going to observe and interact with the settings interface component 512 on the body of the laser apparatus 101. Such settings interface component 512 may comprise a plurality or a sequence of human interface components such as buttons, dials, sliders, switches, or other similar type devices. In one arrangement, the user does not need to interact with the settings interface components 512. Instead, the user may interact with the power switch component 504, which in one arrangement comprises a switch or a button of its own. However, as those of ordinary skill in the art will recognize, alternative switch components may be utilized.

The user will locate the power switch component 504 which in one arrangement comprises a toggle switch, a rocker switch, or a button that one presses. Pressing such a power switch component 504 may require that the user press such a power switch component 504 for a certain period or a certain amount of time. (e.g., 2-5 seconds). Where a rocker switch may be used, the user may be called upon to depress one side of the rocker switch in order to move this switch from the power off state to the power on state. Because this rocker switch is connected to the power source 402 for the central power of the laser beam apparatus 101, power can then begin to flow from the power source component 402 to one or more components of the laser gun device. In one power switch component 504 arrangement, the various components into which power begins to flow may comprise the following components:
the display component 514;
the audio output circuit component 405;
the power transfer circuit component 403;
the data storage component 515;
the firing circuit component 312; and
the display and feedback component 513.

For example, upon receiving power, the display and feedback component 513 will perform its function of reading the current settings and then proceed to display these current settings when the signal is received from the display component 514. Therefore, the display component 514 upon receiving power will illuminate the display. In addition, the display component 514 can prepare to illuminate LEDs by having power flowing through its common pathways. It still needs information, but it is now in what may be called a ready state.

Upon receiving power, the audio output circuit component 405 similarly will not immediately produce any output signal. Rather, the audio output circuit component 405 will enter into a ready state. In this ready state, the audio output circuit component 405 upon receiving power will begin to initialize. In an alternative arrangement, the audio output circuit component 405 may be designed in such a way that upon powering on, the audio output circuit component 405 produces an output signal indicating that the power has been turned on. This could be comparable to a power on audile tone or signal produced by other electronic devices such as a laptop, which cues a user to its boot-up sequence. A sound such as a ding or a click could be used to let the user know that the device has been powered on. So, in that scenario, the audio output circuit component 405 initializes and then produces an audio output signal. This audio output signal can then be passed on to the audio output mechanism component 406 for producing a start-up or a power on sound. That said, this audible signal does not have to be a requirement of the laser beam apparatus 101 but can be an optional feature.

Upon receiving power, the power transfer circuit component 403 enters into what may be called an initialized state. In this initialized state, the power transfer circuit component 403 will be ready to receive a signal from one or more components of the laser beam apparatus 101, such as the firing circuit component 312. The power transfer circuit component 403 will not perform any activities such as transferring power or allowing power to flow. Rather, the power transfer circuit 403 will remain in what may be called a primed or ready state until further instructions are received.

Upon receiving power, the data storage component 515 enters what may be called an initialized state. This initialized state includes making the data that the data storage component 515 stores accessible, readable, or writeable by the other components either internal or external to the laser apparatus 101. The initialization state of the data storage component 515 does not require the data storage component 515 to transmit any data. Rather, in this initialized state, the data storage component 515 stands ready to relay data upon request to any of the components of the laser beam apparatus 101 that require this data.

Upon receiving power, the firing circuit component 312 enters into a what may be called a ready state in which the electronics have powered up, but no activity will be performed until the firing circuit component 312 receives a signal from the trigger mechanism component 510. In this ready state, the firing circuit component 312 can detect a trigger event, such as a triggering event performed by the trigger mechanism component 510. In addition, the firing circuit component 312 may also, upon initialization, request preloaded settings data from the data storage component 515 in order to perform calculations when the trigger event is received. That is an optional functionality of the firing circuit component 312 upon receiving power.

The display component 514 is also initialized upon receiving power. It first powers up its electronic components in the circuit and then proceeds to request settings data from the data storage component 515. The display component 514 uses this requested data to produce the outputs needed to pass along to the display and feedback component 513 so that the current settings and the state of the device can be (and are) displayed. Initially, the display component 514 receives power and enters into what may be called a waiting state. On its own, the display component 514 does not have the ability to display information. However, once the display component 514 has received power, has queried the data storage component 515 for information, and then has used that information to pass it along to the display and feedback component 513, the laser beam apparatus 101 then displays the current settings and state of the apparatus 101 to the user through the display and feedback component 513.

Therefore, in this arrangement, upon powering the device, all components that were in an idle state transition to an initialized state. Again, the audio output circuit component 405 may produce a notification output signal indicating and/or informing the user that the power to the laser beam apparatus 101 has been turned on successfully. Additionally, while everything else has initialized and remains in an idle state, the display component 514 actively performs one or more duties. For example, one duty that the display component 514 performs in that it retrieves the current setting information. Once the current setting information is received, the display component 514 then displays this information, which may include nothing more than an active display showing the power status of the laser beam apparatus 101. In this scenario, the display and feedback component 513 may have that display configured in the form of one or more light elements.

Alternatively, the display and feedback component 513 may be configured as a track comprising a plurality of lights that outlines the laser gun device 101, or other substantially similar visual indicator showing that the power is on. Furthermore, the power switch component 504 itself, which was used to initiate power to the laser beam apparatus 101, may contain illumination such that the user can see that power is on by looking at the switch that they used to perform that action.

In the case where there is no power available for the laser beam apparatus 101, meaning that the central power source battery has been fully depleted or perhaps that an external power source that provides the central power is not available, plugged in, or has been depleted, the user can receive some type of feedback. In this case, the user will have performed the action or actions that are necessary to turn on the laser beam apparatus 101, but instead of seeing a settings display indicating that power is on and displaying the current settings, there will be no visible, illuminated response.

Also, instead of receiving an audio output notification that indicates the power has been turned on successfully, there will be silence. It is the lack of these signals that will indicate to or that will inform the user that a power on activity has failed or is non-existent. In this setup, the user is notified by way of inference. The user has been informed that the state of the laser beam apparatus 101 is such that it does not have power because it cannot operate as expected or designed without requisite energy.

Powering Off Laser Beam Apparatus

The action of powering off the laser beam apparatus 101 is the opposite of what was previously explained. For the user to power down the laser apparatus, in one arrangement, the user will need to move the rocker switch or depress the power switch component 504 while the device is in a “power on” state to the alternative. If the power switch component 504 comprises a momentary push button, the user may need to press and hold it for a certain predetermined period of time, such as one to two seconds so as to enable a power off action. In an arrangement where the power switch component 504 comprises a rocker switch, the user will simply need to move that rocker switch to the position opposite of what it is currently in. When the user initiates a power off action, power is removed or cut off from the laser apparatus components that receive power in a power on scenario.

This would mean that, in one preferred laser apparatus arrangement, the power is removed from the display and feedback component 513, from the audio output circuit component 405, from the power transfer circuit component 403, from the data storage component 515, from the firing circuit component 312, and from the display component 514. If there is illumination or electronic visual feedback on the power switch component 504 itself, that also is turned off as the user moves the power switch component 504 to the power off position. As the power is removed from each of these components that had received power during the startup of the laser beam apparatus 101, there is an option to display to the user that a power off event is occurring. This can be accomplished by removing the illumination from the device display features in a sequence such as dimming the display screen until it is completely dark or turning off each of the display LEDs in a sequence until they are all turned off, indicating that the power has been removed.

The audio output circuit component 405 may also, upon receiving a lack of power, spend some amount of reserve power—or the last of its remaining power—to produce an audible output signal that is transferred to the audio output mechanism component 406, allowing this output mechanism component 406 to generate a “power off” notification. Such signals are not required because the absence of the display information and something akin to the lack of illumination typically provides suitable notification to the user that the laser beam apparatus shutdown has been successful. Still, these are options, and the power off sequence remains less complex than the power on sequence since after removing power the circuits no longer have the ability to operate. Therefore, they simply become inactive.

Plugging Laser Apparatus Into A Power Source

Plugging the laser apparatus into a power source can be performed if the configuration of the power source's component is such that the power is received into the laser gun device from an external source.

Configurations may vary, but for purposes of this description assume that the attached cable comprises a two-pin connector that screws into place in order to secure it. The user grasps the open end of the cable coming from the power source, inserts it into the power port that is exposed on the body or enclosure of the laser gun device. The user can then either twist or clip the power cable to lock the power cable into place depending on the physical design of the mechanism. This action allows the power cable to be inserted which makes it viable for the user to perform a power on action and continue to operate the laser gun device as if it were powered in a different manner. Similarly, the user can unplug from the power source by doing the reverse, which is to press the clip retainer or unscrew the thread to unlock the power port locking mechanism before removing the power cable from the laser gun device's power port.

It is worth mentioning that this is a similar action that the user performs if the remote power source comprises a battery backpack or a wearable battery system. With such a configuration, the power source cable emanating from the battery backpack would be similar to those which are accepted by another type of power source. The action is substantially similar no matter the type of power source. This action is predicated upon whether or not the power source is independent of the body of the laser gun device.

Charging Laser Apparatus

Charging the laser apparatus, such as the laser apparatus 101 illustrated in FIG. 1, is a matter of plugging in a charging cable. In one arrangement, the charge port component 509 is different than the power source component cable as discussed in detail herein. To charge the laser gun device presumes at least one battery of the power source component 402 is attached to, inserted in, or enclosed within the laser gun body. So, instead of the plug-in action that is performed to gain access to an external power source for operation, this act of plugging into an external power source is for the purpose of charging the laser beam apparatus. A key difference—not in this action but in the functionality—is that it is not necessary that the device remain operable throughout this charging process. When considering other types of popular technological devices such as a smartphone or a laptop, some of them allow the user to operate the device while charging, but others do not.

If the laser gun device 101 is using an internal battery as its power source component 402 and the user is charging that battery, then the charging port might be provided as a USB-C port (or any other type of USB port). In one arrangement, the charging cable comprises a magnetically attached charging cable that would make connection when the magnetic device snaps into place. As described in detail herein, in one preferred arrangement, the laser apparatus remains operational as long as the internal battery charge is sufficient for operation while the laser apparatus draws additional power through the charging port. However, it could be preferable to require the user to charge the laser apparatus 101 prior to using the laser apparatus 101 so that one cannot charge it, power it on, and use it at the same time. The reason this might be a more preferred arrangement is because the user is generally not going to be near a power source when firing the laser apparatus 101.

In an arrangement where the power source's component is configured such that the central power is provided by the internal battery, and the power source component 402 for firing or for supplying power to the laser beam generation component 301 comprises an internal battery that is encased or sealed within the laser gun device body, the charging process is the same as described herein. That is, the charging cable is connected to the laser beam apparatus 101 and charging begins automatically. This means that the internal batteries of the laser beam apparatus can accept incoming power to recharge them as part of the power source's component.

In an arrangement where the configuration of the power source component 402 is such that the internal battery is used for powering the central electronics of the laser beam apparatus 101, but the power source for supplying the laser beam generation component 301 comprises a replaceable battery, then charging for that interchangeable battery will not be performed by plugging a cable into the body of the laser apparatus 101. Instead, that procedure would be performed by removing that battery. This removed battery may then be placed into a charging cradle or linking it to a charging device that contains its own cable as a separate component from the laser gun device 101. Charging can be accomplished via multiple methods, but the power source's component configuration determines the manner of charging.

In arrangements, it is possible to provide high-power rapid charging to the laser apparatus 101 which would require a connector with a higher power capacity consisting of a large copper or gold-plated contacts and large gauge conductors instead of something like a USB-C connector. Many of these options depend on the configuration of the device. However, a preferred arrangement would be that the central power source 402 comprises a rechargeable, embedded battery that is enclosed in the laser gun device body and that cannot be removed by the user. This battery is recharged by plugging in a charging cable as described herein, which, of course, charges the battery directly. The rest of the functionality of the device is disregarded in this action, and the body and the power source component are the only parts of the device involved.

In this arrangement, the internal battery first powers the laser apparatus circuitry. Meanwhile, the power source configuration for powering the beam generation unit is a removable, rechargeable battery that is designed, in one arrangement, to imitate a form of an ammunition magazine for a handgun (See, e.g., removable main laser power source component 402). This battery can be interchanged and hot swapped by a user to add more power by simply switching out this battery module. To be clear, in this preferred arrangement, the charging process is a two-step operation. First, referring now to FIG. 2, the user plugs the charging cable into the charging port component 509 of the laser apparatus enclosure component 401 to charge the internal central power rechargeable battery. Second, the user inserts the battery magazine (i.e., the power source for the laser beam generation component 301) into a different charging cradle or module to charge that particular battery unit.

Battery Replacement

Battery replacement applies to the laser apparatus arrangement in which the power source configuration comprises a replaceable battery that can be removed from the body of the laser apparatus. As a result, a new battery can be attached, or in a situation where the user only has one battery, that single battery can be charged and then reintroduced into the device after the battery is sufficiently powered. To replace the battery, in one arrangement, the user interacts with some form of a physical latch or a locking mechanism that is a part of the battery pack on the laser gun device body itself.

There are numerous arrangements that may be implemented to design this battery pack. As one example, the battery pack can be slid inside the handle of the laser apparatus, similar to a handgun magazine such as, for example, illustrated in FIG. 2. In yet another example, the battery pack can be placed on top of the body of the laser gun device so as to distribute the weight evenly and allow for some expansion of the laser gun device body. Perhaps a chin rest or something similar could be provided on the battery pack. Ultimately, the battery pack placement does not matter other than ensuring that the process of attaching and removing the battery pack can be performed even in high-stress scenarios. At the same time, the battery pack should not be in a position on the laser apparatus where the battery pack can be easily removed by happenstance or removed inadvertently. The power source for the laser beam generation component 301 should not be exposed to accidental removal, especially during a hectic moment, such as when trying to fire at a target while the user of the laser apparatus is under duress.

In one arrangement, the battery retaining mechanism comprises a spring-loaded plastic or metal clip. Alternatively, the retaining mechanism comprises a retaining bar or a retaining ring. In one arrangement, the mechanism is designed in such a way that it allows for physical retainment of the battery pack, but then it can also be depressed, squeezed, pushed, or activated by the user in order to release the retaining mechanism. Without the applied pressure at the correct juncture, the battery pack cannot be lifted, slid sideways, or pulled out. The user must intentionally remove the battery pack. Ostensibly, replacing the battery would require the inverse action whereby the user inserts a fully charged battery as a substitute for the spent one.

The electrical conducting terminals, which are found where the battery makes contact with the receptacle conductors on the laser gun body, need to be of sufficient current and voltage capacity such that a clear, clean, stable, reliable, and sufficiently strong electrical connection is made between those conductors. For example, this electrical connection may be accomplished through an action of putting the battery into place and engaging the battery retaining mechanism. The user should not need to perform additional steps in order to secure the battery pack or to make sufficient electrical contact. With an efficient loading motion, the easier it is for the user to add more laser beam shots to the laser gun device while in the field, or during combat, or while caught in a stressful situation. Preferably, the electrical connection is not made separate from the physical connection. Rather, it is preferred if the electrical connection should come together in one motion, wherever the placement of the battery pack may be and whatever the configuration of the retaining mechanism.

Next, a laser apparatus configuration will be considered where the laser gun device only draws its power from a replaceable battery pack and has no internal battery for central power of the circuitry. In this configuration, the replacement of the battery is equivalent to a power off/power on action sequence such that when the battery is removed, the entire laser gun device enters into a power off state from which it can have no memory. This means that when power is reapplied via the insertion of a charged battery pack, the laser apparatus only behaves as if a power on sequence has been enacted. Since there is no “hot-swappable” condition or option, a possible display of the amount of power remaining in the battery pack would be followed just the same as if the user had powered on the device without changing the battery. It makes no difference; it is the same as powering on the device.

However, in a power source configuration where there exists a central, internal, and rechargeable battery, and the device is in a powered-on state, it may through the display component 514 and the display and feedback component 513 reveal some information. As just one example, it might convey how many laser shots remain at the current power setting and the current duration that the user has chosen. If that information is being displayed as a result of powering on the laser gun device, it is now in what may be referred to as a stable, powered condition. Subsequently, if the user removes the interchangeable battery pack that works as the power source for the laser beam generation component 301, then upon removal, the display component 514 will detect this action based on the current power setting, the duration setting, and/or other settings that influence battery life. Based on the lack of presence of a battery pack and the current diminished power supply for powering the laser beam generation component 301, the display component 514 will calculate that zero laser beam shots remain.

That information is sent to the display and feedback component 513 to exhibit it in whatever form has been configured for the device such as an alphanumeric display or a sequence of LEDs representing the number of remaining shots. While there is no battery pack available, it will continue to display that same level. Then, once a battery pack that contains an electrical charge has been inserted into the laser beam apparatus 101, the same sequence of steps will be performed by the display component 514 wherein the voltage or power level of the newly inserted replaceable battery pack is used to assess, based on the other settings, how many laser beam shots remain. That information is then sent to the display component which displays the data in a format as ascribed by the design configuration.

Here is an exemplary scenario related to the above description. Imagine that the user's display component shows forty-five (45) shots remain in the current state of the laser gun device. In response, the user drops out the replaceable battery pack, and then the aforementioned sequence is followed, which leads the display component showing a zero: “0”. When the user inserts a fully charged battery into the laser apparatus, then the aforementioned sequence alerts the display to exhibit the number 180 (i.e., perhaps the maximum number of shots that type of battery pack can provide at the current settings and duration the user has selected for the device).

In that structure, where there is a central rechargeable battery as the power source for the internal circuitry, the circuitry remains powered up from that power source. Meanwhile, the replaceable battery pack to power the beam generation component is dropped out and replaced. Because the power to the laser gun device continues uninterrupted for the internal circuitry, dynamic calculation of remaining shots can be performed. At the same time, not only is the display component 514 displaying the information but also the audio output circuit component 405 may be producing an audio output signal that corresponds to the changing state of the device. Perhaps, in one arrangement, an audio circuit informs the user that a battery pack has been removed and/or has been inserted. This audio confirmation may help the user comprehend that the battery pack has been successfully disengaged and/or reinserted. This function is an optional design choice for usability. It might be a desirable experience for users of the laser gun device. If so, it may be the only other circuit that is activated during the action of replacing the battery. So, in one preferred arrangement, the display component 514, the audio output circuit component 405, and the display and feedback component 513 are the components of the laser beam apparatus 101 that would be impacted by the battery replacement.

Laser Apparatus Focusing

In reference to FIG. 4, the laser apparatus 101 may further comprise a focusing component 322. This action only applies in a design where the output optics component 319 comprises a focusing component, and that focusing component comprises a manual focusing component as opposed to an automatic focusing component. In one configuration, the enclosure or body component 401 of the laser apparatus 101 comprises a rotating ring containing a plurality of ridges or rubber grips that facilitate a way to turn or twist it in order to adjust the optical focus of the outgoing laser beam shot. The patterns on the rotating ring may be such that the user can adjust the focus for a given distance by looking at the markings and the text printed around the focusing ring. As such, the user adjusts the rotating mechanism so as to focus at a first distance (e.g., a distance of about 100 feet) or rotate the ring in the other direction to modify the shot for a second, different distance (e.g., a distance of about 4 feet).

Of course, as this action is related to a portion of the output optics component 319, the optical chamber that the output laser beam shot passes through is altered in terms of its focal length, and the beam focuses on the distance indicated by the text inscribed on the rotating ring. Because changing the focus of the laser gun device does not affect other laser apparatus actions, changing the focus can be done whether the laser apparatus is powered on or powered off. In one preferred arrangement, changing the focus may also be performed while firing the laser apparatus 101.

Changing the focus simply impacts the state of the output optics component 319 while all other components of the laser beam apparatus 101 remain steady. Moreover, if the configuration of the output optics component 319 is such that auto-focus technology has been implemented, then the auto-focus technology can be performed in addition to allowing the user to manually focus. These auto focus and manual focus functions do not have to be mutually exclusive.

Alternatively, if the laser beam apparatus 101 is designed in a way that auto-focus is the only means of focusing, then the user will not be able to perform a manual focus action. In arrangements, the laser gun device 101 automatically or spontaneously focuses as the user aims the laser gun device 101 at a target, or perhaps at the moment when the user begins to trigger the laser beam apparatus 101. To reiterate, in a preferred arrangement, unless the laser beam apparatus 101 is designed to be manually focused, the act of focusing is preferably not available to the user.

In an alternative arrangement, the focus component 422 comprises an auto-focus feature to be initiated by the user. Auto-focus may be initiated when the user pushes an auto focus button on the device that activates the auto-focus capabilities of the output optics component 319. This would then instruct or initiate the laser beam apparatus 101 to engage and/or perform an auto-focus activity on behalf of the user.

Status Viewing

Numerous components of the laser beam apparatus 101 are involved in viewing the status of the laser beam apparatus 101. For example, as a user seeks to understand the state of the apparatus regarding everything from how much energy remains in the apparatus to how many laser beam shots remain, the user is called upon to consider the display and feedback component 513, the body enclosure 401, the settings interface 512, the display component 514, and the power switch component 504.

First, in determining whether the laser gun device is in an on or an off state, the power switch component 504 can feature markings as to the switch's orientation or position. In addition, the power switch component 504 might also be illuminated. Either way, the user can determine the power state of the laser beam apparatus 101 by looking at the condition of the power switch or button component 504. The user simply maneuvers the body enclosure component 401 to see the power switch component 504 or button and its position with regards to its operational status. If illumination is part of the design, then an illuminated button and/or switch provides a visualization that the power is on. If the power switch component 504 comprises a momentary push button, then illumination becomes a characteristic that indicates its state because there is no other distinction with regards to its position. The button looks the same whether the device is in a powered on or powered off condition.

One possible arrangement would be to create a running track of diffused illumination that travels along the top edge of the laser gun device 101. When the device 101 is in a power on condition, the entire strip of LEDs will be illuminated. Such an arrangement would not only be useful in helping a user to observe the power status from numerous angles, but it could also increase the aesthetic appeal of the laser gun device.

Moreover, when the laser gun device is powered on, the current state of the display component is indicated by illumination, color change, and/or several other options with regards to visual indicators or representations that are part of the laser gun device's implemented design. Obviously, the mere presence of the display component's illumination also indicates that power is turned on because without power this component would not work.

There are additional items of information regarding the status of the laser apparatus and its various functions that need to be viewed within the display component 514. For example, the user might want to view one or more safety settings. Noting the safety setting of the laser gun device not only involves the display component and the body enclosure, but it also involves the display component 514 and the settings buttons and dials component. One way for the user to comprehend the safety setting is to look at the position of a safety component 508 as illustrated in FIG. 2. In one arrangement, this safety component 508 may comprise a non-illuminated rocker switch marked with text or featuring a symbol which indicates that in one direction safety is not applied, but in the other direction, it is applied. The physical switch indicates the condition of the safety setting.

A more intricate and user-friendly design would be to illuminate the safety component 508 so a user can see the switch without having to closely inspect it. Another alternative would be to employ a variance of colors such that when the safety component 508 is illuminated a particular first color (e.g., green), the colored switch is indicating the device's safety switch is engaged. Similarly, when the safety component 508 is illuminated a second color (e.g., red), the safety switch has been turned off. The safety component 508 may comprise a push button, a rocker switch, a toggle switch, or even a slide switch. In the case where a track of illumination is used to indicate the power, perhaps that track of LEDs is changeable by a color such that if it is illuminated, it indicates power is on, but the color of the illumination informs the user as to whether the safety is turned on or not. Again, in this scenario, the red or green track of lights indicate the safety status of the laser gun device. In arrangements, this is how the display component of the laser apparatus can indicate the status of the safety setting.

Regarding the safety setting, it is possible to include the data storage component 515 in this action as well. The safety setting could be a digitally stored setting, meaning that the safety setting remains in place even when the device is powered off and powered back on. In this way, the safety setting can be changed through electronic means such as pushing and holding a safety release button that digitally changes the safety setting, which will remain in its changed status until the user interacts with that component again. This might not appear in the form of a switch. Rather, it may be designed as a momentary push button with digital encoding wherein the data storage component 515 would retain the information regarding that safety setting which would be passed along to the user via the tracks of light or by an LED indicator. It may be that the display component is only able to display the safety setting once the display component 514 component queries the data storage component 515, retrieves information about that safety setting, and then produces the output signal needed to display an alphanumeric message or illuminate the laser beam apparatus 101.

An additional status that the display component 514 is responsible to communicate is the number of estimated laser beam shots that remain, or the equivalent which might be the percentage of power remaining in the laser gun device. To display this information, the display component 514 reads the voltage level or the information output from the battery that is contained within the enclosure of the device or within its interchangeable battery pack.

Included in this status reading would also be the electrical signal coming from an external power source if that is where the available power is coming from. The display component 514 assesses the power level, which can then be divided by the settings to calculate how much power is needed to apply per laser pulse or laser shot—as well as at what duration—to determine the number of laser beam shots possible with the current available power level. It verifies the level of energy that seems to be available from the power source and then it signals that information to the display component in order to initiate its display. In one arrangement, this could be performed by a plurality of LEDs. Alternatively, this could be performed by an alphanumeric (or numeric) display. It could also be performed by a combination of LEDs and an alphanumeric display. Similar to the concept regarding the safety displays, the laser apparatus might use bright white LEDs to indicate that the user has access to full power while a dimming of those lights indicates a reduction of power and, consequently, a reduction in the number of remaining laser beam shots. As those of ordinary skill in the art will recognize, alternative lighting and illumination configurations may also be used.

Another status update that the user might want to access is knowledge about whether the laser beam apparatus 101 has any error codes regarding the proper operating condition of the device. The display component 514 would access such information as it is provided by other circuits in the form of a voltage. A positive voltage indicates that the laser beam apparatus 101 is in working order, while a no or a “0” voltage value indicates that something is wrong with the laser beam apparatus 101. The display component 514 can then drive the display and feedback component 513 to show whether or not the laser beam apparatus 101 appears to be in good working condition with all of its components reporting successful initiation and initialization as well as successful idle mode.

To be clear, any other status appraisal or information update for the laser gun device that is not included or discussed herein will operate in substantially the same order as has been explained. For example, it is worth mentioning that the display component 514 may trigger the command of the audio output circuit component 405 to produce an audio signal and send it to the audio output mechanism component 406, indicating whether a negative status or a positive status situation has been reached. In that way, a user can be made aware of apparatus status through an ambient tone or noise that reaches their consciousness even if they are not looking at the apparatus. An error that is noticed within the status of the laser beam apparatus 101 could also prompt the display component 514 to command the audio output circuit component 405 to issue an audio notification indicating that there is something wrong and that perhaps the device will not function as intended.

Viewing Settings

The act of viewing laser apparatus settings is much like viewing the status of the laser apparatus, except viewing the settings will require user interaction to select which setting they want to see. One form of viewing the settings would be for the user to manipulate the laser gun device body enclosure so that he or she can inspect the associated buttons, dials, sliders, switches, etc. The physical configuration of these components allows the user to navigate and adjust the settings, but they also allow the user to ascertain the current status of these settings just by looking at them. In the case of sliders or dials, markings would indicate the current position of the controls. For example, a dial related to the power level per shot might go from a minimum value (e.g., 1) to a maximum value (e.g., 100). For example, if the user can see that this dial is set to 82, then the user can accurately ascertain the power level of his or her next shot. Another example might be the use of a slider to indicate shot duration options between five milliseconds and one second. Again, the user can determine from the position of the slider what the duration of the next shot will be. This form of viewing the settings is the same as determining the power status of the laser gun device by noting the physical position of the power switch 504.

If the user wants to view the settings in a different way, the laser beam apparatus 101 may also comprise features of a multifunction rotary encoder dial with digital settings and coding capabilities. If so, then the display provided for viewing the settings may comprise an alphanumeric display that can show a small amount of information at a time. This might be a preferred arrangement for settings due to having a reduced number of moving parts and a reduced number of switches or dials with which a user needs to learn how to interact.

Viewing the settings in this configuration involves the user positioning the laser gun device body such that they can view and interact with the settings. There may be a dial or button that both triggers the display of the current settings and switches back and forth between the various functions that can be featured in the settings display. As the user interacts with the button or the dial, the display component 514 receives a signal that a change in position has been applied to that control module which correspondingly adjusts the signal being sent to the alphanumeric display of the display component. That signal can also be used by the display to show the proper setting.

For example, a user turns the dial, and it shows the power level not just as a number but something more specific like: “POWER: 82”. Then, when the user turns the dial another stage or step clockwise, they are effectively telling the laser gun device that they would like to see the next setting in sequence. In our example, this is the shot duration setting. So, the display component 514, after receiving that positional change signal from the settings dial, renders the display signal as “DURATION: 5 ms.”

In such an arrangement, multiple components of the laser beam apparatus 101 may be involved in the viewing of the settings. The settings buttons component is involved because the user acts upon it. The settings and display component 514 notes that change and then queries the data storage component 515. The data storage component 515 returns the information, and the settings and display component 514 provides the output to the display component for the user to view. Additionally, it is also feasible to arrange for the settings and display component 514 to command the audio output circuit component 405 to produce an audible notification informing the user that the settings currently being viewed have been changed. In addition, there could also be an audible tone for indicating that the setting is available to be viewed.

Changing Settings

In one arrangement, changing of the settings of the laser apparatus 101 illustrated in FIG. 1 requires the user to interact with the settings interface component 512 (which is part of the body enclosure) in combination with the display component 514. This action also involves the data storage component 515, and it could involve the audio output circuit component 405 and the audio output mechanism component 406 as well.

A user would change the settings after having viewed the current settings and determining an adjustment is necessary or desired. In order to begin the process, the user positions the body of the laser beam apparatus 101 so that they can see and gain access to the settings interface component 512. If the user is looking at a dial to change the power level of the laser beam shot, the user rotates the dial to the desired position. That change in position is recognized by the display component 514, which receives a signal in the form of a changed voltage or changed signal path for the current flow. The display component 514 calculates the new settings information that needs to be stored and sends that information as a write request to the data storage component 515 to change the stored setting in the data storage. Additionally, after calculating and recording the new setting, the display component 514 issues a display output signal to the display component to indicate the newly updated setting on that component.

Optionally, the display component 514 could also send a signal to the audio output circuit component 405 instructing the audio output circuit component 405 to generate an audio signal to send to the audio output mechanism component 406, so that the user can hear a notification that the setting has been successfully altered. For example, in an arrangement where the user turns the dial from, for example “82” to “90”, and for every 1% increase in the power setting the user hears an audible click or beep coming from the laser beam apparatus 101. This tone emanates from the audio output mechanism component 406, and the new settings are rapidly and sequentially recorded into the data storage component 515: for example, “82”, “83”, “84”, “85”, “86”, “87”, “88”, “89”, and “90”. In one arrangement, this numerical progression will end at the point or number where the user stopped the dial.

The display is being updated throughout this process as well. In other words, the user can see the numbers scroll from “82” to “90” as he or she turns the dial and hears the clicking—or whatever the audio confirmation tone might be. After completing the action, the user can visually confirm that the laser gun device's power setting rests on “90.” Now, the display shows “90,” the dial is in a static position, and if the user were to shut down power to the laser apparatus and then power the apparatus back on later, they would see that the setting remains at “90” regardless of how long the device had been turned off.

Other settings of the laser beam apparatus 101 can be changed in a similar fashion. For example, in one arrangement, each setting is made accessible through its own physical interaction component, meaning each setting has its own dial, switch, and/or slider. Alternatively, there could be a configuration where each of the laser gun device's settings and functions are available through a single dial. In this type of arrangement, the encoding of the different settings can be achieved by pressing inward on the rotating dial to use it as a push button that transitions from one setting to the next. This could also be devised as a set of buttons that change which setting is being enabled, but the dial is used to scroll the digits higher or lower. Additionally, there could be a single dial for settings but a secondary button that is used for saving the changes after the user has completed the task.

Similar interfaces can be found on other pieces of electronic equipment.

Essentially, the activity begins with the user desiring a change and then interacting with the settings buttons component in order to make that change. The downstream effect follows through the circuitry of the laser apparatus as described herein, ending with the storage of that setting in the data storage component 515 after the change has been completed.

Aiming Laser Apparatus

In the laser apparatus arrangement where the aiming mechanism component 511 comprises a barrel that is attached directly to the main body of the laser gun device, aiming is a matter of the user directing the position of the barrel such that it points at the target just like the user would point a handgun, rifle, or comparable device. The aiming is complete when the user positions the aiming mechanism component 511 toward their desired target in a satisfactory fashion.

If the aiming mechanism component 511 comprises a swivel-mounted lens, then the user rotates the lens on the swivel while holding the body of the laser gun steady thereby compensating for its variation. After this pivot, the position of the aiming mechanism component 511 is pointed at the desired target. If the aiming mechanism component 511 comprises a wearable module similar to an output lens that is attached or clipped onto a vest, shoulder strap, or a helmet, the user aims the device by turning their own body such that the aiming mechanism 511 is now pointing toward the desired target.

Firing Laser Beam Apparatus

The act of firing the laser beam apparatus 101, like the laser beam apparatus 101 illustrated in FIG. 1, involves an act where the laser beam apparatus user 201 of the laser beam apparatus 101 decides that they would like to fire the laser gun device. Therefore, as previously described, the user 201 has already aimed the laser beam apparatus, the user has also already powered the apparatus on, the user has also viewed and changed settings (if necessary), and so the apparatus is in a state of being ready to fire.

In one preferred arrangement, the user interface for firing comprises a trigger or an initiation device, such as the trigger mechanism component 510 illustrated in FIG. 2. As described in detail herein, the trigger mechanism component 510 may be mounted in some way to the enclosure of the body of the laser beam apparatus 101. As also described in detail herein, this trigger mechanism component 510 may comprise either a pull trigger like on a handgun or a button, or a grip that you squeeze. In either type of arrangement, the user initiates the firing action by pulling the trigger mechanism component 510. Once the trigger mechanism component 510 is activated, the trigger mechanism component 510 allows the flow of power, just like a regular electrical switch. In one preferred arrangement, this power flow comprises a temporary flow of power. That is, when a user releases the trigger mechanism component 510, power will no longer flow, and the power that does flow arrives as an input to the firing circuit component 312.

The firing circuit component 312 then is responsible for determining if the laser beam apparatus 101 should fire. Now, the firing circuit component 312 retrieves certain information when it queries the data storage component 515 to read one or more of the current settings. In addition, the firing circuit component 312 determines the current state of whether or not the laser beam device 101 is in safety mode as this safety mode has already been described herein. As herein described, one way for the user to comprehend the safety setting of the laser beam apparatus 101 is to look at the position of a safety component 508 as illustrated in FIG. 2.

Moreover, the firing circuit component 312 may also determine how many laser beam shots or laser beam bursts are remaining within the laser beam apparatus storage system. For example, the firing circuit component 312 can determine if there are one or more laser beam shots or bursts remaining. In the case where the firing circuit component 312 determines that there are perhaps zero shots remaining, the firing circuit component 312 may not initiate the firing of the laser beam apparatus 101.

In one preferred arrangement, the firing circuit component 312 performs one or more calculations when this firing circuit component 312 receives the current settings and the current state of the laser beam apparatus 101 from the data storage component 515. And if the laser beam apparatus 101 currently resides where the safety setting is in the on state or active state, then the firing circuit component 312 ceases to perform further functions. That is, the firing circuit component 312 does not need to perform any further activity, and because the safety of the laser beam apparatus 101 is in the on or active state, preferably the firing event should not occur. Similarly, if any other information such as an error condition is known and/or is determined by the settings interface component 512, and that can be read by the firing circuit component 312, then the firing circuit component 312 may also determine that it is not to initiate a firing condition.

Alternatively, if the safety setting of the laser beam apparatus 101 is in an off position or in an inactive state, then the firing circuit component 312 utilizes the current settings of the laser beam apparatus 101. For example, in one arrangement, the laser beam apparatus 101 may use the power level and the duration to calculate and/or determine what type of signal to send to the power transfer circuit component 403. And so, in sending the signal to the power transfer circuit component 403, the firing circuit component 312 is in essence, enabling the flow of power, such that the laser beam 202 eventually generated by the laser beam apparatus 101 can be initiated. And simultaneously, as the firing circuit component 312 sends its correctly timed signal to the power transfer circuit component 403 with the correct power volume and the correct timing duration, the firing circuit component 312 also sends a signal to the audio output circuit component 405. In one preferred arrangement, the signal directed to the audio output circuit component 405 may be used to initiate an audio signal that can be indicative of a firing event.

And so, in one preferred laser beam apparatus arrangement, the audio output circuit component 405 receives a signal. And if the structure of the audio output circuit component 405 is such that it can render computer files such as wave or MP3 files, this audio output circuit component 405 may then upon receiving the signal to fire or to produce a firing event, may perform one or more queries. For example, the audio output circuit component 405 may query the data storage component 515 in order to retrieve one or more sound files. These one or more sound files may then be communicated to the audio output mechanism component 406 for potential playout.

So, the audio output circuit component 405 then proceeds. This is operating in parallel with what is happening at the power transfer circuit component 403, as will be discussed herein. But the audio output circuit component 405 then produces an output audio signal which it sends to the audio output mechanism component 406. This audio output mechanism component 406 then produces one or more sound waves that the user can hear for a firing event. For example, such an output can be a loud event, such as an event of 120 decibels and thereby indicating (to the user as well as others in the vicinity) that the laser beam apparatus 101 has fired or is firing an output laser beam shot, such as the laser beam 202 illustrated in FIG. 1.

And so what happens then back at the power transfer circuit component 403 is the signal that arrives is used to drive the MOSFET transistors of solid state relays to allow power to flow. And the power then begins to flow from the power source component 402, which serves as the power source for powering the laser beam generation component 301. This power begins to flow from a power source. As described herein, in one preferred arrangement, this power source comprises a battery from a replaceable interchangeable battery magazine that can be clipped and/or inserted into the laser beam apparatus 101. Once this battery is connected into the apparatus 101, the power flows from that battery pack at a very high rate through one or more solid state relays of the power transfer circuit component 403 that had been opened for only a certain duration.

And only to the extent allowed by the instructions provided by the firing circuit component 312, which means that the amount of power flowing through for the duration is how the firing circuit component controls, how long and how powerful of a burst of laser beam output is produced. As the power flows from the power source to the solid state relays of the power transfer circuit, it arrives then at the laser beam generation component, a beam generation component, and it then arrives inside that component and arrives as the input to the pump laser diodes.

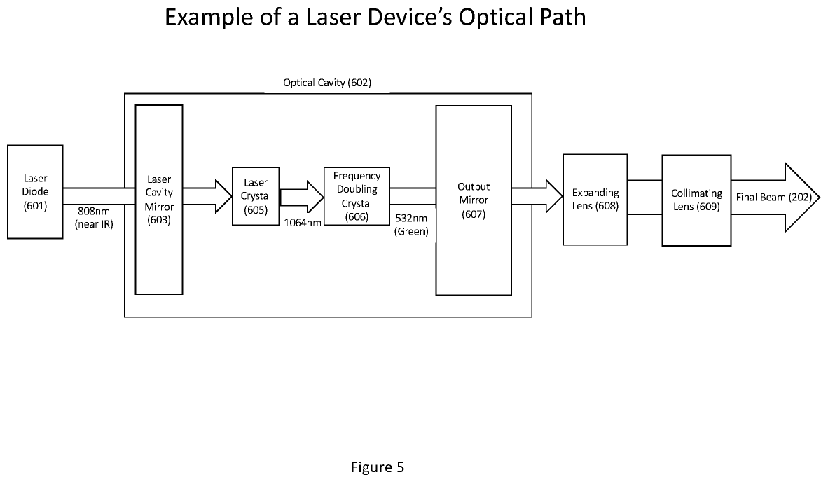

As will be described in greater detail with respect to FIG. 5, the pump laser diodes consume the electricity without any intelligence or consideration. In one preferred arrangement, the pump laser diodes consume just the amount of electricity that is supplied. And these laser pump diodes therefore, produce pump laser light, which then arrives at a bulk crystal that resides in a resonant optical chamber. This bulk crystal then absorbs the pump light and then the atoms of the bulk crystal are elevated to a higher energy state and then some generated laser beam photons from the bulk crystal are admitted and echo through a resonance chamber.

After a population inversion occurs, a cascade effect occurs and the output laser beam begins to flow. This generated laser beam then passes inside the chamber and also passes through a second harmonic generation crystal, such as a crystal made of potassium titanyl phosphate, or KTP. This second harmonic generator then converts that energy into a different wavelength. The output of the laser beam generation component 301 is then 532 nanometer green laser light which comprises an acceptable level of collimation and is diffraction limited.

And then the laser beam exits the laser beam apparatus as, for example, a one-millimeter beam and at a very high power level. The input power pump light may have been approximately 200 Watts of electricity arrived from the power source into the pump laser diodes. The pump laser diodes emit 100 Watts of pump light, and after absorption transmission another 50% of the energy is lost. As such, approximately 50 Watts of green laser energy in a short burst is created, and may be a 20 millisecond burst that is emitted from the beam generation component and passes into the output optics component 319.

In one preferred arrangement, the output optics component 319 is configured such that it comprises a beam expander, which may be a Galilean beam expander. This beam expander expands the diameter of a one-millimeter beam to a four and a half millimeter beam. The output optics component 319 then corrects the collimation at this beam size, such that the exiting laser beam comes out of the final lens of the output optics component and comprises a beam that is four and a half millimeters in diameter and is well collimated.

In this manner, the exiting laser beam will travel tens of meters while still in a high energy concentration and will impact an intended target that resides between zero and approximately 40 meters from the exit of the laser beam apparatus 101.

In one preferred arrangement, the various elements of the output optics component 319 are housed in an aiming mechanism, such as the aiming mechanism 511 illustrated in FIG. 2. For example, the aiming mechanism 511 may comprise a barrel or open barrel construction that is releasably or permanently affixed to the body of the laser beam apparatus 101.

And so, the output laser beam shot exits out of a final lens of the output optics component 319 and passes out of the aiming barrel mechanism, the barrel of the laser gun device and travels toward its target. The exiting laser beam shot arrives at its intended target while traveling at the speed of light and then impacts the intended target. In one preferred arrangement, all of the time that this laser beam shot is being produced and exits the laser beam apparatus 101, the audio output mechanism component 406 is projecting a loud sound that occurs, in one arrangement, simultaneously with the emitting of the laser beam shot. This loud sound indicating that the shot has been fired, is similar to how when a hand gun is fired and the bullet projectile moves forward the reverberation of the loud sound of the gun blast is heard simultaneously. And as a consequence, the laser beam shot has been fired and arrives at its intended target.

And then as the laser beam shot is generated and exits the laser beam apparatus 101, the heat remover component 503 is configured so as to collect a certain quantity of heat that is emitted by the various components in the laser beam generation component 301 and in the power source component 402. The heat remover component 503 moves this heat through the radiating material of the remover component 503. As described in detail herein, aside from a copper based heat remover component 503, alternative heat remover radiating materials may also be utilized. As just one example, in a preferred arrangement, the heat remover component 503 comprises a copper heat dissipating structure that comprises one or more dissipating fins. The heat remover component 503 can be housed inside a cage structure that protects the heat remover from damage and/or protects the heat remover from being accidentally touched by a user, but through which air can flow in the laser apparatus body.

In one preferred arrangement, the air flow is over the fins of the heat remover component 503 and the radiating heat from the single laser shot begins to make its way out of the system, such that the various heat producing elements of the laser beam apparatus 101 can arrive back at stasis temperature. In a preferred arrangement, the heat remover component 503 will eventually arrive at the temperature it had before the laser being shot was fired through the laser beam apparatus 101. And now that this anticipated heat dissipation has occurred, the 200 Watts for a brief period of energy, that was drawn from the power source battery pack has been dissipated.

And so that battery pack (i.e., power source component 402) having radiated off some heat, now has a lower energy level. And so shortly after the firing, because it is regularly querying, the settings interface component 512 is measuring the change of energy level of the battery pack. And now based on its computations, the settings and display component 512 queries the data storage component 515 for the settings, as it regularly does to display the settings and using that information that it calculates that the remaining number of laser blast shots is now one fewer than it was before. And then finally, the data storage component 515 sends a signal to the settings and display component 512 to update the display.

The act of firing the laser beam apparatus 101 as previously described requires an output optics component 319. For example, FIG. 5 illustrates a block diagram of certain optical generation components of a handheld laser beam device, such as the laser beam apparatus 101 illustrated in FIG. 1. In this exemplary circuit arrangement, an initial laser beam 600 is generated by a near-infrared, diode-pumped solid-state laser 601. For example, the initial laser beam 600 may be generated at an 808 nm wavelength. This initial laser beam 600 may be referred to as pump light.

As illustrated, this generated laser beam 600 enters an optical cavity 602 via a laser cavity mirror 603. In this exemplary arrangement, the laser cavity mirror 603 is approximately 100% reflective on its inner surface for certain wavelengths but is transparent to 808 nm. However, as those of ordinary skill in the art will recognize, alternative reflective laser cavity mirror arrangements may also be used. After exiting the laser cavity mirror 603, the laser beam 600 excites a laser crystal 605. The laser crystal 605 provides an amplification of the incoming laser beam 600 by way of its doped structure. In the exemplary arrangement illustrated in FIG. 5, an example of the type of laser crystal 605 that can be used comprises a neodymium-doped yttrium orthovanadate (Nd:YVO₄) laser crystal. In such a laser crystal, the neodymium ions are excited by a near-IR input beam, resulting in an emission of coherent near-IR light at a wavelength of 1064 nm.

In this exemplary arrangement, the wavelength of 1064 nm is then halved by passing the 1064 nm wavelength beam through an optional frequency doubling crystal 606. For example, such a frequency doubling crystal 606 may comprise a KTP (potassium titanyl phosphate) frequency doubling crystal 606. The Frequency Doubling Crystal 606 results in producing a 532 nm wavelength (visible green light) beam. As those of ordinary skill will recognize, the Frequency Doubling Crystal 606 may only be necessary if a shorter wavelength light is desired as an output, for example wavelengths on the order from about 255 nm to 702 nm.

The beam exits the optical cavity through an Output Mirror 607, which allows only 532 nm light to leave the cavity. That beam is then expanded via an Expanding Lens 608, and then finally passes through a Collimating Lens 609 for final beam collimation so as to produce a final beam 602.

The description of the different advantageous embodiments has been presented for purposes of illustration and description, and is not intended to be exhaustive or limited to the embodiments in the form disclosed. Modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A laser apparatus comprising:
a power switch component configured to power on the laser apparatus;
a settings interface component configured to allow i. a change to one or more settings or ii. a change to one or more configurations of the laser apparatus;
a data storage component configured to store laser apparatus information;
a display component in communication with the data storage component and configured to display i. a current setting or ii. a state of the laser apparatus;
a display and feedback component configured to read at least one current setting, the display and feedback component configured to display the at least one current setting when a signal is received from the settings and display circuit;
a trigger mechanism component configured to allow an activation of the laser apparatus so as to energize the laser apparatus to create a laser beam;
a firing circuit component configured to receive an electrical activation signal from the trigger mechanism component and generate a firing signal based in part on this electrical activation signal;
a power transfer circuit component configured to receive the firing signal from the firing circuit component,
based in part on this firing signal, the power transfer circuit component transfers power to a laser beam generation component;
at least one power source component configured to provide power to the laser beam generation component,
the laser beam generation component generating a laser beam; and
an output optics component configured to receive the laser beam generated by the laser beam generation component.

2. The laser apparatus of claim 1, wherein
the power source component comprises a rechargeable, embedded battery that is enclosed in an enclosure component of the laser apparatus.

3. The laser apparatus of claim 1, wherein
the power source component comprises an external power source that is external to the laser apparatus.

4. The laser apparatus of claim 3 further comprising:
a power port for receiving a cable from the external power source.

5. The laser apparatus of claim 4 wherein,
the external power source comprises a battery backpack or a wearable battery system.

6. The laser apparatus of claim 1, wherein
the power source component comprises a rechargeable, removable battery that is enclosed in an enclosure component of the laser apparatus.

7. The laser apparatus of claim 1 further comprising:
a charge port component for charging the power source of the laser apparatus.

8. The laser apparatus of claim 7 wherein,
the charge port component comprises a USB port.

9. The laser apparatus of claim 1 wherein,
the output optics component comprises a focusing component,
wherein the focusing component comprises a manual focusing component.

10. The laser apparatus of claim 9, wherein,
the manual focusing component comprises
a rotating ring comprising one or more ridges or rubber grips that facilitate turning or twisting the rotating ring in order to adjust the optical focus of the outgoing laser beam shot.

11. The laser apparatus of claim 1 wherein,
the output optics component comprises a focusing component,
wherein the focusing component comprises an auto-focus component.

12. The laser apparatus of claim 1 wherein,
the display component further comprises
a safety component configured to prohibit an undesired firing of the laser apparatus when the safety component resides in an on position.

13. The laser apparatus of claim 1 wherein,
the output optics component further comprises
an aiming mechanism component configured to direct a laser energy output generated by the laser apparatus towards a prospective target.

14. The laser apparatus of claim 13 wherein,
the aiming mechanism component comprises a swivel-mounted lens,
wherein a lens is rotatably mounted on a swivel, such that aiming of the laser apparatus occurs when the lens is rotated while holding a body of the laser apparatus.

15. The laser apparatus of claim 1, wherein,
the laser apparatus is activated to generate one or more bursts of energy.

16. The laser apparatus of claim 1, wherein,
when the power switch component resides in an off position, the trigger component is prevented from activating the laser apparatus.

17. The laser apparatus of claim 1, wherein,
the settings interface component comprises at least one of the following: a button, a momentary push button, a dial, a slider, a touch sensitive device, or a push/on-push/off button.

18. The laser apparatus of claim 1, wherein,
the at least one power source component comprises a first power source dedicated to a central electrical system for operating the laser apparatus.

19. The laser apparatus of claim 18, wherein,
the at least one power source component comprises a second power source dedicated to a laser beam generation component of the laser apparatus.

20. The laser apparatus of claim 19, wherein,
the second power source dedicated to the laser beam generation component of the laser apparatus comprises a high discharge rate battery.

21. The laser apparatus of claim 20, wherein,
the second power source dedicated to the laser beam generation component comprises a removable battery pack.

22. The laser apparatus of claim 21, wherein,
the removable battery pack comprises a hot-swappable battery pack.

23. The laser apparatus of claim 21, wherein,
the removable battery pack comprises a wearable battery pack that can be worn by a user of the laser apparatus.

24. The laser apparatus of claim 1, wherein,
the display and feedback component comprising
at least one haptic feedback module configured to provide a perceptible sensation that a user feels while holding the laser apparatus.

25. The laser apparatus of claim 1, further comprising:
an audio output circuit component configured to produce an audio output signal.

26. The laser apparatus of claim 25 wherein,
the audio output circuit component communicates the audio output signal to an audio output mechanism component,
the audio output mechanism component configured to produce a start-up or a power on sound.

27. The laser apparatus of claim 26 wherein,
the audio output mechanism component comprises a piezoelectric mechanism.

28. The laser apparatus of claim 25 wherein,
the audio output circuit component comprises a digital analog converter that receives an .WAV or .MP3 audio file and produces an output signal.

29. The laser apparatus of claim 1 wherein,
the power transfer circuit component comprises a plurality of solid-state relays.

30. The laser apparatus of claim 1 wherein,
the data storage component comprises a memory card.

31. The laser apparatus of claim 1 wherein,
the data storage component comprises embedded memory.

32. The laser apparatus of claim 1 wherein,
the laser beam generation component comprises one or more laser diodes.

33. The laser apparatus of claim 1 wherein,
the laser beam generation component comprises a diode-pumped solid-state laser.

34. The laser apparatus of claim 33 wherein,
the diode-pumped solid-state laser comprises at least one diode coupled to a fiber optic.

35. The laser apparatus of claim 34 wherein,
the fiber optic comprises a doped fiber.

36. The laser apparatus of claim 1 wherein,
the laser beam generated by the laser beam generation component comprises a pulsed laser beam.

37. The laser apparatus of claim 1 wherein,
the laser beam generation component comprises a laser modulator component.

38. The laser apparatus of claim 34 wherein,
the laser modulator component comprises an acoustic optical modulator.

39. The laser apparatus of claim 1 wherein,
the output optics component comprises an open-air passageway.

40. The laser apparatus of claim 1, wherein
the output optics component shapes and collimates the generated laser beam.

41. The laser apparatus of claim 40 wherein,
the output optics component focuses the generated beam to a central point a distance away from the laser apparatus.

42. The laser apparatus of claim 37 wherein,
the output optics component provides the generated beam as a collimated beam.

43. The laser apparatus of claim 1, further comprising:
a heat remover component configured to disperse heat generated by the laser apparatus.

44. The laser apparatus of claim 43 wherein,
the heat remover component comprises a passive heat remover.

45. The laser apparatus of claim 43 wherein,
the heat remover component comprises an active heat remover.

46. The laser apparatus of claim 1, wherein
the laser apparatus comprises a laser apparatus.

47. A directed-energy source comprising:
a firing circuit that receives an activation signal from a trigger mechanism and generates a firing signal based on the activation signal;
a transfer circuit that receives the firing signal from the firing circuit, the transfer circuit transfers power to a laser beam generator,
wherein the laser beam generator comprises a diode-pumped solid-state laser comprising a diode coupled to a doped fiber optic,
at least one power source configured to provide power to the laser beam generator for generating a laser beam; and
an output optics component configured to receive the laser beam generated by the laser beam generation component.

48. A method of emitting energy from a directed-energy source, comprising the steps of
providing a power switch component to power on the laser apparatus;
utilizing a settings interface component to allow i. a change to one or more settings or ii. a change to one or more configurations of the laser apparatus;
storing laser apparatus information in a data storage component;
enabling communication between a display component and the data storage component and configured to display i. a current setting or ii. a state of the laser apparatus;
configuring a display and feedback component to read at least one current setting,
the display and feedback component configured to display the at least one current setting when a signal is received from the settings and display circuit;
allowing an activation of the laser apparatus so as to energize the laser apparatus to create a laser beam;
receiving an electrical activation signal from a trigger mechanism component;
generating a firing signal based in part on the electrical activation signal;
receiving the firing signal from a firing circuit component by way of a power transfer circuit component,
utilizing the power transfer circuit component to transfer power to a laser beam generation component;
providing power to the laser beam generation component,
generating a laser beam by the laser beam generation component; and
receiving the laser beam generated by the laser beam generation component by an output optics component.
